(19) United States
(12) Patent Application Publication
(10) Pub. No.: US 2026/0285687 A1
(43) Pub. Date: Sep. 24, 2026

(54) POROUS CARBON MATERIAL, MANUFACTURING METHOD OF THE SAME, AND ENERGY STORAGE DEVICE WITH THE SAME

(71) Applicant: 3DC Inc., Miyagi (JP)

(72) Inventors: Hirotomo NISHIHARA, Miyagi (JP); Takuma KURODA, Miyagi (JP); Atsuo OMARU, Miyagi (JP)

(73) Assignee: 3DC Inc., Miyagi (JP)

(21) Appl. No.: 18/997,975

(22) PCT Filed: Jul. 25, 2023
(86) PCT No.: PCT/JP2023/027293

§ 371 Date: Jan. 23, 2025

(30) Foreign Application Priority Data
Jul. 25, 2022 (JP) 2022-118199

(51) Int. Cl. C01B 32/194; C01B 32/186; H01G 11/26; H01G 11/32; H01M 4/62

(52) U.S. Cl. CPC C01B 32/194; C01B 32/186; H01G 11/26; H01G 11/32; H01M 4/625; C01P 2002/72; C01P 2002/82; C01P 2002/88; C01P 2004/03; C01P 2004/04; C01P 2004/20; C01P 2004/61; C01P 2004/62; C01P 2006/16; C01P 2006/40

(57) ABSTRACT

Provided are a porous carbon material that can realize an energy storage device having a high rate characteristic, a manufacturing method of the porous carbon material, and a lithium-ion battery storing the porous carbon material inside electrodes. The porous carbon material has a graphene framework in which a plurality of pores are provided inside a primary particle forming the porous carbon material, and the particle diameter of the primary particle is 300 nm or greater and 30 μm or less. Also provided are a cathode and an anode for an energy storage device in which the porous carbon material is used as a conductive agent and an energy storage device.

### TECHNICAL FIELD

The present invention relates to a porous carbon material, a manufacturing method of the same, and an energy storage device with the same and, more particularly, relates to a structure called carbon mesosponge (CMS) or Graphene MesoSponge® (GMS) and a manufacturing method of the same and to a capacitor and a lithium-ion rechargeable battery in which the structure is used for an electrode active material or a conductive agent.

### BACKGROUND ART

In recent years, efforts to realize a sustainable society have attracted attention. In particular, active research and development to achieve carbon neutrality that reduces overall greenhouse gas emissions to zero is underway, and global research on a novel carbon material intended to increase performance of energy storage devices such as rechargeable batteries or electric double-layer capacitors (EDLC) is on-going.

Graphene is one of the novel carbon materials and is excellent in thermal conductivity, electroconductivity, and mechanical (tensile) strength, and research thereon has been made for application to various fields such as electronics, energy materials, or the like. Research and development on Graphene MesoSponge® as such a graphene structure is on-going, and because of its large specific surface area and electrical conduction characteristics, Graphene MesoSponge® is expected to be used in energy storage devices such as anode active materials of batteries or electrode auxiliary materials of EDLCs.

As a manufacturing method of porous carbon materials including graphene, in particular, Graphene MesoSponge®, a method of coating the surface of template particles with carbon, then removing the template particles, and performing heat treatment on a carbon material at a high temperature to manufacture Graphene MesoSponge® is known (Patent Literatures 1 and 2). As a method of coating the template surface with carbon, a chemical vapor deposition (CVD) method is known. Specifically, Patent Literatures 1 and 2 disclose use of methane as a source gas in the CVD method, Patent Literature 1 discloses use of alumina nano-particles as template particles, and Patent Literature 2 discloses use of magnesium oxide nano-particles as template particles.

### CITATION LIST

### Patent Literature

### [PTL 1]

Japanese Patent No. 6460448

### [PTL 2]

Japanese Patent Application Laid-Open No. 2021-84819

### SUMMARY OF INVENTION

### Technical Problem

Terms used in the present specification about template particles will now be described. For nano-particles of alumina, magnesium oxide, and the like, a case of forming these nano-particles by, for example, a bottom-up liquid phase method will be illustrated as an example. Herein, nano-particles are defined such that uniform nano-particles are formed in a liquid, the nano-particles are then aggregated non-uniformly in the liquid and formed as a structure, the structure is then dried into powder, and this powdered structure is referred to as nano-particles, and a porous body is defined such that nano-particles are non-uniformly aggregated in a liquid and formed as a structure, the structure is then dried into powder, and this powdered structure is referred to as a porous body. Further, the minimum unit of structures forming powder of porous bodies is referred to as a primary particle of a porous body. For example, a particle observed by SEM or the like after powder of porous bodies is dispersed by ultrasonic waves, homogenizer, or the like corresponds to the primary particle of porous bodies.

In general, nano-particles are likely to be aggregated as they are, and it is observed by SEM or the like that powder materials used in Patent Literatures 1 and 2 are also likely to become powder whose minimum unit structure is secondary particles aggregated from nano-particles.

With respect to the carbon material of Patent Literature 1, secondary particles aggregated from alumina nano-particles are used as templates to be coated with carbon, respectively, the alumina secondary particles as templates are then dissolved, the residuals are subjected to high-temperature heat treatment, and thereby a GMS is formed. With respect to the carbon material of Patent Literature 2, secondary particles aggregated from magnesium oxide nano-particles are used as templates to be coated with carbon, the magnesium oxide secondary particles as templates are then dissolved, the residuals are subjected to high-temperature heat treatment, and thereby a GMS is formed. In Patent Literatures 1 and 2, a high specific surface area corresponding to the specific surface area of the secondary particles as templates can be realized by the above formation method.

In the porous carbon materials in Patent Literatures 1 and 2, however, there is a problem that nano-particles used as templates are likely to be aggregated, this makes it difficult to coat pores inside the aggregated body with carbon, and this results in an insufficient amount of carbon inside pores of the porous carbon material after removal of the template. Further, there is a problem of reduced device performance when such a porous carbon material is used for devices.

In a case of EDLCs as an example of devices, conduction paths are limited for reasons such as an insufficient amount of carbon formed in pores inside the aggregated body, and this causes a problem such as an increased diffusion resistance and thus a reduced electrostatic capacitance or charging rate.

Further, in a case of lithium-ion rechargeable batteries as an example, in particular, in lithium-ion rechargeable batteries intended for application of electric vehicles (EV) or the like, the amount of a conductive agent has been increased for the purpose of reducing the electrode resistance to improve output characteristics. As a result, the amount of the active material that is the source of the capacity is reduced, and it is not possible to achieve both high power and high capacity at the same time.

The present invention has been made in view of the above circumstances and intends to provide a porous carbon material that does not reduce device performance, a manufacturing method of the porous carbon material, and a capacitor or a lithium-ion rechargeable battery in which the porous carbon material is used for an electrode active material or a conductive agent.

### Solution to Problem

As a result of intensive study, the inventors have found that a porous carbon material having a graphene framework in which a plurality of pores are provided inside a primary particle forming the porous carbon material and the particle diameter of the primary particle is 300 nm or greater and 30 μm or less has more conduction paths than the carbon materials as with Patent Literatures 1 and 2, thus reduces the diffusion resistance obtained when used as an energy storage device, and contributes to realize an energy storage device, for example, a capacitor or a lithium-ion rechargeable battery having a high rate characteristic.

That is, the present invention provides the following configuration.
(1) A porous carbon material having a graphene framework, wherein a plurality of pores are provided inside a primary particle forming the porous carbon material, and wherein the particle diameter of the primary particle is 300 nm or greater and 30 μm or less.
(2) The porous carbon material according to (1) described above, wherein the primary particle has a plate-like shape, (in-plane direction length)×(thickness) of the plate-like shape being 100 nm to 30 μm×10 nm to 1000 nm.
(3) The porous carbon material according to (1) or (2) described above, wherein the primary particle has a plate-like shape, the porous carbon material having: a first wall mainly forming a surface extending in a plate-like manner (primary surface); and a second wall formed inside the primary particle and forming a part of a partition inside a particle.
(4) The porous carbon material according to any one of (1) to (3) described above, wherein a diffusion resistance of a capacitor obtained with the porous carbon material is 20Ω or less.
(5) The porous carbon material according to any one of (1) to (4) described above, wherein a pore diameter of the porous carbon material is 2 nm or greater and 50 nm or less.
(6) A manufacturing method of a porous carbon material, the manufacturing method having: a coating step of coating a porous template with a carbon layer to obtain a molding, a primary particle diameter of the porous template being 300 nm or greater and 30 μm or less; and a separation step of dissolving the porous template with acid to separate the molding from the porous template.
(7) The manufacturing method of the porous carbon material according to (6) described above further having, prior to the coating step, a heat treatment step of performing heat treatment on the porous template.
(8) The manufacturing method of the porous carbon material according to (6) or (7) described above, wherein the porous template is formed of particles made of oxide of alkali earth metal.
(9) The manufacturing method of the porous carbon material according to any one of (6) to (8) described above, wherein the oxide of alkali earth metal is magnesium oxide.
(10) The manufacturing method of the porous carbon material according to any one of (6) to (9) described above, wherein in the separation step, the porous template is dissolved with acid not containing hydrofluoric acid.
(11) The manufacturing method of the porous carbon material according to any one of (6) to (10) described above further having, after the separation step, a stabilization step of performing heat treatment on a molding separated from the porous template by the separation step.
(12) The manufacturing method of the porous carbon material according to any one of (6) to (11) described above, wherein an average framework thickness of the porous template is 70 nm or less.
(13) An electrode for a capacitor, the electrode comprising an electrode with the porous carbon material according to (1).
(14) An anode for an energy storage device, the anode including the porous carbon material according to (1) as a conductive agent.
(15) A cathode for an energy storage device, the cathode including the porous carbon material according to (1) as a conductive agent.
(16) An energy storage device comprising a cathode and/or an anode including the porous carbon material according to (1) as a conductive agent.

### Advantageous Effects of Invention

According to the present invention, with the use of a porous template having a suitable primary particle diameter, it is possible to provide a porous carbon material and a manufacturing method thereof that is less affected by aggregation. With the use of the porous carbon material, it is possible to realize a capacitor, which is an energy storage device with improved device performance such as a rate characteristic as an example, and a high-power energy storage device having a cathode and/or an anode including the porous carbon material as a conductive agent.

### BRIEF DESCRIPTION OF DRAWINGS

FIG. 1A is a schematic perspective view illustrating an example of a configuration of a porous carbon material according to one embodiment of the present invention.

FIG. 1B is a schematic sectional view taken along the line A-A of FIG. 1A.

FIG. 2A is a schematic perspective view illustrating an example of a configuration in which a plurality of porous carbon materials of FIG. 1A are overlapped.

FIG. 2B is a schematic sectional view taken along the line A-A of FIG. 2A.

FIG. 3 represents an equivalent circuit model in measurement of a diffusion resistance of a capacitor obtained by using the porous carbon material of FIG. 1 and FIG. 2.

FIG. 4A is a schematic perspective view illustrating an example of a configuration of a porous template used for a manufacturing method of a porous material according to one embodiment of the present invention.

FIG. 4B is a schematic sectional view taken along the line B-B of FIG. 4A.

FIG. 5A is a diagram illustrating a manufacturing method of the porous material according to one embodiment of the present invention, which is a schematic perspective view illustrating an example of a configuration of a molding obtained by a coating step.

FIG. 5B is a schematic sectional view taken along the line C-C of FIG. 5A.

FIG. 6A is a diagram illustrating the manufacturing method of the porous material according to one embodiment of the present invention, which is a diagram illustrating a view of a separation step.

FIG. 6B is a schematic sectional view taken along the line C-C of FIG. 6A.

FIG. 7A is a schematic perspective view illustrating an example of a configuration of a porous material according to a modified example for FIG. 1.

FIG. 7B is a schematic sectional view taken along the line E-E of FIG. 7A.

FIG. 8 is an electron microscope image of a porous template used in Example 1.

FIG. 9A is a ×30,000 SEM image of a porous template of Manufacture example 2.

FIG. 9B is a ×100,000 SEM image of the porous template of Manufacture example 2.

FIG. 10A is a ×30,000 SEM image of a molding of Manufacture example 3.

FIG. 10B is a ×100,000 SEM image of the molding of Manufacture example 3.

FIG. 11A is a ×30,000 SEM image of the porous carbon material of Example 1.

FIG. 11B is a ×100,000 SEM image of the porous carbon material of Example 1.

FIG. 12A is a ×30,000 SEM image of a porous carbon material of Example 2.

FIG. 12B is a ×100,000 SEM image of the porous carbon material of Example 2.

FIG. 13 is a SEM image of a carbon material of Comparative example 1.

FIG. 14A is a TEM image of a porous template of Manufacture example 2.

FIG. 14B is a TEM image of the porous template of Manufacture example 2.

FIG. 15A is a TEM image of a molding in which the porous template of Manufacture example 3 is coated with a carbon layer.

FIG. 15B is a TEM image of the molding in which the porous template of Manufacture example 3 is coated with the carbon layer.

FIG. 16A is a TEM image of the porous carbon material of Example 1.

FIG. 16B is a TEM image of the porous carbon material of Example 1.

FIG. 17A is a TEM image of a porous carbon material of Example 2.

FIG. 17B is a TEM image of the porous carbon material of Example 2.

FIG. 18 represents a particle size distribution of the porous carbon materials of Example 1, Example 2, and Example 2-B, the porous templates of Manufacture example 1 and Manufacture example 2, and the molding of Manufacture example 3.

FIG. 19 represents a particle size distribution of porous carbon materials of Example 2 and Example 2-B and carbon materials of Comparative example 1, Comparative example 2, and Comparative example 3.

FIG. 20A represents XRD analysis results of Manufacture example 1 and Manufacture example 2.

FIG. 20B represents the analysis results of Manufacture example 1 and Manufacture example 2 illustrated in FIG. 20A that are overlapped with each other with the scale of the vertical axes being matched and also illustrates the peaks of magnesium hydroxide.

FIG. 21 represents XRD analysis results of Example 1 and Example 2.

FIG. 22 represents Raman spectra of Example 1, Example 2, and HOPG.

FIG. 23 represents nitrogen adsorption/desorption isotherms of the porous carbon materials of Example 1 and Example 2.

FIG. 24 represents nitrogen adsorption/desorption isotherms of the porous templates of Manufacture example 1 and Manufacture example 2 and the molding of Manufacture example 3.

FIG. 25 represents a pore size distribution of the porous templates of Manufacture example 1 and Manufacture example 2 and the molding of Manufacture example 3.

FIG. 26 represents a pore size distribution of the porous carbon materials of Example 1 and Example 2.

FIG. 27 represents a TG curve of the porous template of Manufacture example 1.

FIG. 28 represents a TG curve of the molding of Manufacture example 3.

FIG. 29 represents TG curves of the porous carbon materials of Example 1 and Example 2.

FIG. 30 is a diagram illustrating the TG curve of the porous carbon material of Example 2 together with TG curves of other carbon materials.

FIG. 31 is a diagram illustrating an ultra-sensitivity vacuum TPD device used in Example 1 and Example 2.

FIG. 32A represents gas emission patterns when temperature-programmed desorption analysis is performed on Example 1.

FIG. 32B represents gas discharge patterns when temperature-programmed desorption analysis is performed on Example 2.

FIG. 33A represents an equivalent circuit model for finding diffusion resistances in Example 4-1 and Comparative example 4-1.

FIG. 33B represents a Nyquist plot for Example 4-1.

FIG. 33C represents a Nyquist plot for Comparative example 4-1.

FIG. 34 represents a graph illustrating rate characteristics of Example 4-1 and Comparative example 4-1.

FIG. 35A represents an equivalent circuit model for finding diffusion resistances in Example 4-2 and Comparative example 4-2.

FIG. 35B represents a Nyquist plot of Example 4-2.

FIG. 35C represents a Nyquist plot of Comparative example 4-2.

FIG. 36 is a schematic sectional view of an energy storage device (lithium-ion rechargeable battery) according to one embodiment of the present invention.

FIG. 37 is a diagram illustrating discharge curves with different current values during discharge of the energy storage device (lithium-ion rechargeable battery) according to one embodiment of the present invention.

### DESCRIPTION OF EMBODIMENTS

An example of embodiments of the present invention will be described below. The present invention is not limited to examples below. The drawings used in the following description are schematic diagrams in which a characterized feature may be enlarged for convenience for easier understanding of features of the present invention. Accordingly, the quantity/amount, the dimensional ratio, or the like of each component may differ from those in the actual implementation. The material, the dimension, the quantity/amount, or the like represented in the following description are examples, and the present invention is not limited thereto and can be changed as appropriate and implemented within the scope not changing the spirit of the invention.

### [Graphene MesoSponge®]

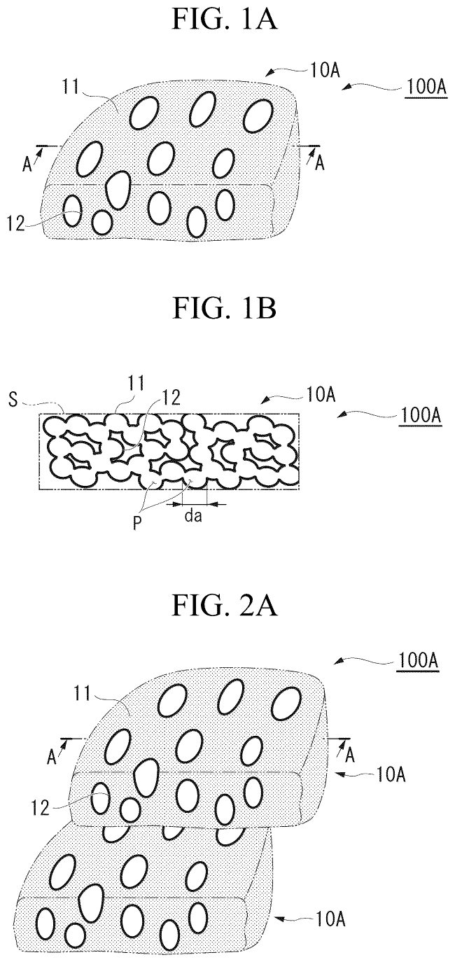

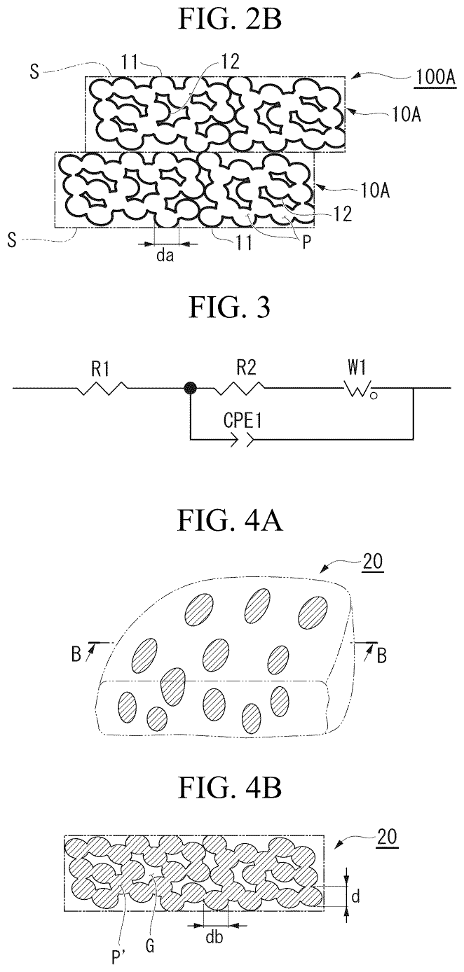

FIGS. 1A and 1B are a perspective view illustrating an example of the configuration of a porous carbon material according to one embodiment of the present invention (FIG. 1A) and a sectional view taken along the line A-A of the perspective view (FIG. 1B). FIGS. 2A and 2B are a perspective view illustrating an example of the configuration in which a plurality of porous carbon materials of FIG. 1A are overlapped (FIG. 2A) and a sectional view taken along a line A-A of the perspective view (FIG. 2B). The porous carbon material of the present embodiment includes a carbon mesosponge (CMS) and a Graphene MesoSponge® (GMS) obtained from the CMS. In FIGS. 1A and 1B and FIGS. 2A and 2B, a GMS is illustrated as an example. The GMS 100A illustrated in FIGS. 1A and 1B and FIGS. 2A and 2B is a porous carbon material having a graphene framework, a plurality of pores P are provided inside a primary particle 10A forming the GMS 100A, and the particle diameter of the primary particle 10A is 300 nm or greater and 30 μm or less. FIGS. 1A and 1B and FIGS. 2A and 2B illustrate the GMS as an example of the porous carbon material, and the dot patterns in FIGS. 1A and 1B and FIGS. 2A and 2B indicate that the material is in a stabilized state due to heat treatment on the CMS. Details of the heat treatment on the CMS will be described later.

The fundamental framework of the GMS 100A is graphene. For example, the GMS 100A has one or more layers of graphene frameworks. In the GMS 100A, the average number of stacking layers N of graphene is, for example, 0.9 to 5.0, preferably 1.0 to 2.0. The smaller the number of laminations of graphene is, the larger the specific surface area of the porous carbon material will be.

The average number of stacking layers N of graphene in the GMS 100A can be calculated by the following formula (1) based on a result of TG measurement. In formula (1), W_{carbon} (g/g) denotes a carbon loading found from the weight at a reference temperature and the weight after the carbon material is burned, Sₜₑₘₚₗₐₜₑ (m²/g) denotes a specific surface area of a template, W_{M} (g/m²) is a carbon quantity deposited per template unit area, W_{graphene} denotes a weight per unit area of graphene. Values W_{carbon} (g/g) and Sₜₑₘₚₗₐₜₑ (m²/g) are calculated by TG measurement.

$$[ Eq . 1 ]$$

$${N}_{stack} = \frac{{W}_{M}}{{W}_{graphene}} = \frac{{W}_{carbon}}{{S}_{template} {W}_{graphene}} \qquad ( 1 )$$

The specific surface area of the GMS 100A is, for example, 800 to 2300 m²/g, preferably 1500 to 2300 m²/g, more preferably 1800 to 2300 m²/g. A larger specific surface area results in a higher yield for the GMS weight relative to the template weight. Further, a larger specific surface area of the GMS 100A results in a larger capacity for an energy storage device. The specific surface area of the GMS 100A is calculated by a BET method conforming to JIS Z8830: 2013.

The pore diameter da of the pore P provided inside the primary particle of the GMS 100A is, for example, 1 nm or greater and 50 nm or less; or 2 nm or greater and 50 nm or less or may be 1.5 nm or greater and 30 nm or less; or 2 nm or greater and 10 nm or less. In such a way, the GMS 100A has the mesoporous structure having a mesopore, for example.

The pore diameter da of the pore P is calculated by a BJH method conforming to JIS Z8831-2: 2010.

The particle diameter of the primary particle 10A (primary particle diameter) of the GMS 100A is 300 nm or greater and 30 μm or less as described above, or may be 300 nm or greater and 20 μm or less; or 300 nm or greater and 10 μm or less. The primary particle diameter of the GMS 100A is measured via a SEM image observed by a scanning electron microscope. Specifically, the GMS 100A obtained after dispersed by ultrasonic treatment for 30 minutes by using an ultrasonic disperser or after dispersed by treatment for 10 minutes by using a homogenizer is observed with SEM images at a magnification range of 5,000 to 50,000. The average of the largest diameters of 100 randomly selected primary particles 10A of the GMS 100A is defined as the primary particle diameter of the GMS 100A (note that a plurality of primary particles to be observed may be included in a single observed image). Further, the particle size distribution of the GMS 100A measured by a laser diffraction method or the like ranges from 300 nm to 30 μm, however, may be present at 300 nm or greater and 20 μm or less; or 500 nm or greater and 10 μm or less, and may be present at 1 μm or greater and 20 μm or less.

Further, when the GMS 100A is a plate-like particle, the in-plane direction length of the primary surface of the primary particle 10A includes a longer diameter in the longitudinal direction thereof (which means the maximum diameter of the primary particle and thus has the same meaning as the primary particle diameter) and a shorter diameter, which is the maximum diameter in the shorter direction orthogonal to the longitudinal direction, and is calculated by the same method as the scheme to calculate the primary particle diameter described above. The in-plane direction length of the primary particle 10A of the GMS 100A is measured for primary particles having the maximum diameter of 300 nm or greater in SEM images captured by a scanning electron microscope. The longer diameter of the primary particle 10A of the GMS 100A is, for example, 300 nm to 100 am or may be 500 nm to 50 μm. The shorter diameter of the primary particle 10A is, for example, 100 nm to 30 μm or may be 300 nm to 10 μm. The thickness of the primary particle 10A is 10 nm to 15 μm or may be 30 nm to 1 μm. The thickness of the primary particle 10A is found by selecting any diameter of 300 nm or greater of particles (not limited to the maximum diameter of the particles) in a SEM image captured by a scanning electron microscope, selecting a particle whose lengths taken orthogonal to the selected diameter are all less than or equal to ⅓ of the selected diameter, measuring the minimum value of the length orthogonal to the selected diameter, and averaging measurement values on 100 randomly selected primary particles.

For example, the GMS 100A is formed of one or a plurality of porous particles having the porous shell structure resulted from a porous template described later. The porous shell structure is the structure corresponding to the shape of a porous template and, for example, has a shape reflecting the surface shape of the porous template.

In the GMS 100A, for example, the primary particle 10A has a plate-like shape. Although indicated by the two-dot chain line in FIG. 1A and FIG. 2A, the contour of the GMS 100A is not limited thereto. For example, the GMS 100A has a first wall 11 mainly forming the plate-like primary surface S and a second wall 12 formed within the primary particle 10A and forming a part of a partition inside the particle. Although indicated by the two-dot chain line in FIG. 1B and FIG. 2B as schematic diagrams, the primary surface of the GMS 100A is not limited thereto. Further, the first wall 11 may form a part of the plate-like primary surface S. Note that the primary particle 10A being a plate-like shape can be confirmed by the fact that the ratio of the diameter selected above relative to the thickness of the primary particle diameter calculated above is three or greater. The ratio of the diameter selected above relative to the thickness of the primary particle diameter is preferably 5 or greater in terms of the diffusion resistance, more preferably 10 or greater.

The first wall 11 is a portion forming a part of the primary surface S, for example, the top surface or the bottom surface of the GMS 100A. The second wall 12 is a portion located inside the primary particle between the two primary surfaces S of the GMS 100A. For example, the second wall 12 includes walls extending in a direction along the primary surface S and walls extending in a direction intersecting the primary surface S, and the interior of the GMS 100A is divided into small compartments by these walls. In the primary particle 10A of the GMS 100A, a plurality of pores P defined by the first wall 11 and the second wall 12 or by a plurality of second walls 12 are provided.

An EDLC is illustrated as an example of a device to which the GMS 100A according to the present embodiment is applied. The EDLC produced by using the GMS 100A has a capacitor diffusion resistance of 22Ω or less, preferably 20Ω or less, more preferably 18Ω or less.

Herein, the diffusion resistance described above is a diffusion resistance measured between two electrodes of a capacitor obtained by using a paste that is a mixture of the GMS 100A, a conductive agent, and a binder. The mixture ratio of the GMS (Graphene MesoSponge®), the conductive agent, and the binder in the mixture for forming the capacitor described above is 70 to 95:20 to 0:30 to 1.

Assembly of a two-electrode cell for obtaining the above diffusion resistance will be described below. First, a GMS, a conductive agent, and a binder quantified to have the mixture ratio described above were mixed to produce a paste, and two sheets of molded bodies each having a weight of 5 mg and a size of 1 cm×1 cm were prepared. Next, the molded body was interposed between Pt meshes and pressurized and crimped by a handpress at a displayed pressure of around 3 KN to obtain an electrode. Two sheets of these electrodes were prepared so as to have the same weight in weight ratio and used as a cathode and an anode, respectively. After the produced electrodes were dried in vacuum at 120° C. overnight, a coin cell was assembled in a glove box under an argon atmosphere.

In the assembly of the coin cell, a spring, a spacer, an electrolyte liquid, the anode, a separator (glass fiber), an electrolyte liquid, the cathode, an electrolyte liquid, and a spacer were laminated in this order in the lamination direction and contained between outer bodies. In the assembly of the coin cell, the electrodes and the separators were lightly tightened by hand and then crimped by using a dedicated assembly apparatus (model number: HSMCC-H10, by Hosen Corporation). As the electrolyte liquid, 1M Et₄NBF₄/propylene carbonate (PC) can be used.

A potentiogalvanostat (Bio-Logic: VMP3) was used to perform electrochemical measurement on the coin cell produced in such a way. Specifically, after the coin cell was allowed to stand for 24 hours in an incubator maintained at 25° C., impedance measurement was performed before cyclic voltammetry or constant current charge/discharge measurement was performed. Fitting was performed on the obtained data by using analyzing software ZView2 to estimate the diffusion resistance. An equivalent circuit model illustrated in FIG. 3 was used for the analysis. FIG. 3 represents the equivalent circuit model in measurement of the diffusion resistance of the capacitor obtained by using the porous carbon material of FIG. 1 and FIG. 2. In FIG. 3, R1 denotes a solution resistance, R2 denotes a charge transfer resistance, CPE1 denotes an interface capacitance, and W1 denotes a diffusion resistance.

The total pore volume of the GMS 100A is, for example, 0.5 to 6.0 cm³/g, preferably 1.0 to 5.0 cm³/g, more preferably 1.2 to 4.0 cm³/g. The total pore volume of the GMS 100A is calculated by obtaining an adsorption/desorption isotherm via nitrogen adsorption/desorption measurement and converting an amount of nitrogen adsorption at a relative pressure P/P₀ of 0.96 at −196° C. into a volume at the density of liquid nitrogen.

### [Manufacturing Method of the Porous Carbon Material]

The manufacturing method of the porous carbon material according to the present embodiment has a coating step of coating, with a carbon layer, a porous template in which the primary particle diameter is 300 nm or greater and 30 μm or less to obtain a molding and a separation step of dissolving the porous template with acid to separate the molding from the porous template. Further, the manufacturing method of a Graphene MesoSponge® further has, after the separation step, a stabilization step of performing heat treatment on the molding separated from the porous template by the separation step. Preferably, the manufacturing method of a Graphene MesoSponge® according to the present embodiment further has a heat treatment step of performing heat treatment on the porous template prior to the coating step. The manufacturing method of the porous carbon material according to the present embodiment will be described below with reference to FIG. 4A to FIG. 7B as appropriate. In FIG. 4A to FIG. 7B, the same features as those in FIGS. 1A and 1B are labeled with the same references, and the description thereof will be omitted.

### Heat Treatment Step

First, heat treatment is performed on the porous template. FIG. 4A is a schematic perspective view illustrating an example of the configuration of the porous template used in a manufacturing method of the porous material according to one embodiment of the present invention, and FIG. 4B is a schematic sectional view taken along the line B-B of the perspective view. FIG. 4A and FIG. 4B illustrate a view of a porous template 20 immediately before the coating step performed later. The porous template 20 illustrated in FIG. 4A and FIG. 4B is the primary particle of the template material and has a three-dimensionally structured framework part P′ therein. The primary particle diameter of the porous template 20 is 300 nm or greater and 30 μm or less. For the primary particle diameter of the porous template 20, the longer diameter, the shorter diameter, and the thickness can be observed by the same method as that for the primary particle diameter of the GMS 100A.

Further, the primary particle of the porous template is formed of a porous body.

The heat treatment on the porous template is performed under an inert gas atmosphere, under an air atmosphere, or under vacuum, for example. In the heat treatment on the porous template, heating is performed, for example, at 400 to 1100° C., preferably at 500 to 1000° C., more preferably at 600 to 950° C. The heat treatment on the porous template is performed, for example, for 0.1 to 3 hours, preferably 0.2 to 1 hour. By performing heat treatment on the porous template under the conditions as described above prior to the coating step, it is possible to decompose impurities if the impurities have been mixed in the porous template. As a specific example, when a porous template formed of magnesium oxide is used, heat treatment causes magnesium hydroxide or magnesium carbonate mixed in the template to be decomposed and released from the template. The above heat treatment step can increase the specific surface area S of the porous template and increase the pore diameter db.

The porous template 20 illustrated in FIG. 4A and FIG. 4B is a template having porous structure formed of any material, is preferably formed of oxide of alkali earth metals in terms of avoidance of use of hydrofluoric acid in the separation step, and is more preferably formed of magnesium oxide (MgO), calcium carbonate, or calcium oxide. Note that, when hydrofluoric acid is used in the separation step, the porous template 20 formed of alumina, zeolite, or the like can be used. For example, a plurality of gaps G defined by the framework part P′ are provided inside the porous template 20.

The average framework thickness d of the porous template 20 is, for example, 5 to 70 nm, preferably 7 to 40 nm, more preferably 10 to 30 nm. The larger the average framework thickness d is, the more the carbon framework exhibits flexibility.

The average framework thickness d of the porous template 20 is found by formula (2) below. The average framework thickness d is the equivalent sphere diameter of the framework of the porous template 20. That is, the diameter d when a sphere having the same specific surface area as a unit framework of the porous template 20 is assumed is found by formula (2). Herein, the specific surface area (BET specific surface area) of the porous template 20 in this formula is calculated by the BET method conforming to JIS Z8830: 2013.

$$d = 6. \times {10}^{3} / ( S \times ρ ) \qquad ( 2 )$$

(In this formula, d denotes the average framework thickness [nm], p denotes the density of materials forming the porous template [g/cm³], and S denotes the BET specific surface area of the porous template [m²/g].)

### Coating Step

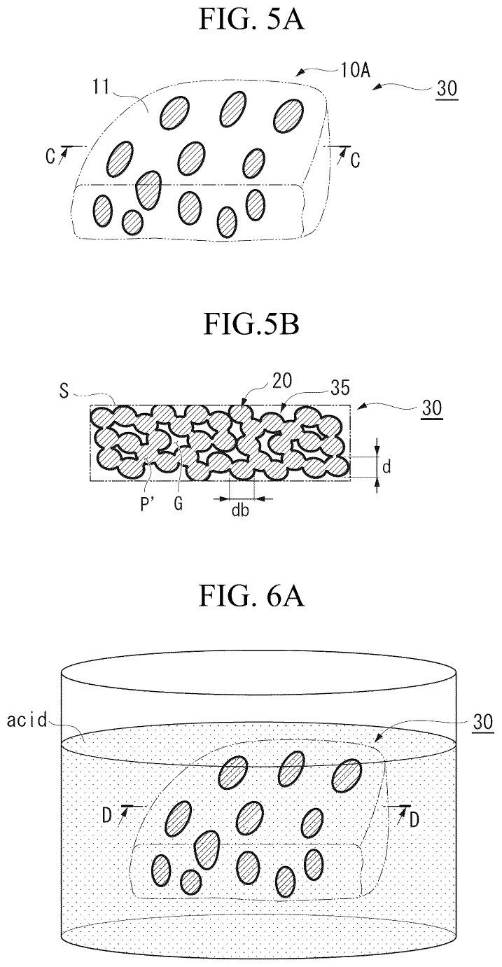

Next, the porous template 20 illustrated in FIG. 4A and FIG. 4B is coated with a carbon layer 35 to obtain a molding 30. Specifically, the surface of the porous template 20 is coated with the carbon layer 35. FIG. 5A is a diagram for illustrating the manufacturing method of the porous material according to one embodiment of the present invention, which is a schematic perspective view illustrating an example of the configuration of a molding obtained by the coating step, and FIG. 5B is a schematic sectional view taken along the line C-C of the perspective view. In the molding 30 illustrated in FIGS. 5A and 5B, the porous template 20 is coated with the carbon layer 35 (black bold lines). The carbon layer 35 is formed along the surface shape of the framework part P′ of the porous template 20.

The coating with the carbon layer 35 on the porous template 20 may be performed by, for example, any of a wet method such as an impregnation method or a dry method such as a chemical vapor deposition (CVD) method, and a wet method and a dry method may be combined to perform the dry method after performing the wet method. For the coating with the carbon layer 35 in the coating step, it is preferable to utilize the chemical vapor deposition (CVD) method, which is a dry method, in terms of controlling the number of stacking layers of carbon layers 35 to be formed to one or more layers.

The present embodiment will be described below with an example of a scheme to coat the porous template 20 with the carbon layer 35 by a CVD method to obtain the molding 30. The coating with the carbon layer 35 by the CVD method may be divided into multiple times to be performed.

In the coating step, as a source gas of the CVD method, an organic compound such as acetylene, methylacetylene, ethylene, propylene, isoprene, cyclopropane, methane, ethane, propane, benzene, toluene, vinyl compounds, ethylene oxide, methanol, ethanol, acetonitrile, or acrylonitrile is used. It is preferable to use acetylene, ethylene, propylene, methane, or ethane as the source gas in terms of easier entry of the gas into the gaps G of the porous template 20.

When performed by the CVD method, the coating step is performed with heating in which the heating temperature can be, for example, 400 to 1500° C., and the pressure in performing the CVD can be, for example, 1 to 200 kPa. Further, the rate of temperature rise in the coating step is, for example, 1 to 50° C./min.

In the coating step, for example, an inert gas may be used as a carrier gas in addition to the source gas described above. Further, as the carrier gas, a gas containing an oxygen gas, a hydrogen gas, or the like may be used other than the inert gas. In the coating step, it is preferable to control the flow speed of the carrier gas to be 0.05 to 1.00 m/min and control the amount of the source gas relative to the total amount of the source gas and the carrier gas to be 1 to 60% by volume in terms of coating with 1 to 2 layers of the carbon layers 35.

In the coating step, when a wet method is performed, for example, an organic compound may be impregnated for carbonization.

Further, after the coating step, the heat treatment may be performed on the porous template 20 having the surface coated with the carbon layer 35 by the coating step. For example, the heat treatment temperature is a temperature higher than the heat treatment temperature in the coating step, such as 900 to 1400° C. For example, this heat treatment is performed by a method using a high-frequency induction heating furnace or a discharge plasma sintering (SPS) method. This heat treatment may be performed under either an atmospheric atmosphere or an inert gas atmosphere and is preferably performed under a reduced pressure. With such heat treatment, carbonization of the carbon layer 35 can be facilitated.

### Separation Step

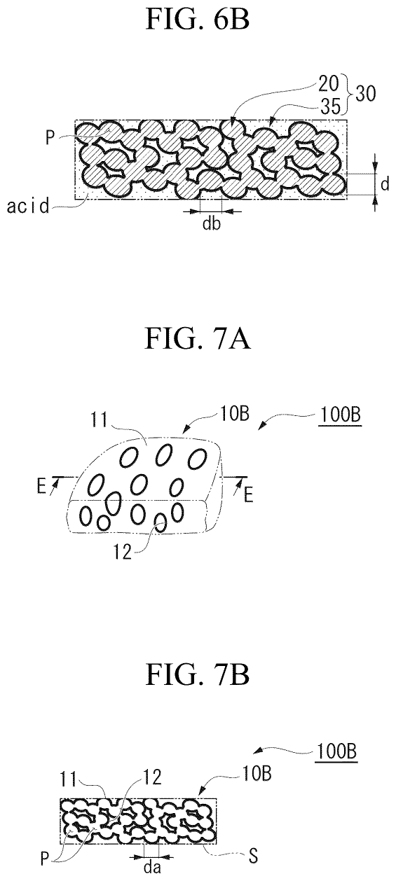

Next, the porous template 20 is dissolved with acid or the like to separate the molding 30 described above from the porous template 20. FIG. 6A and FIG. 6B are diagrams illustrating the manufacturing method of the porous material according to one embodiment of the present invention, which are diagrams illustrating a view of the separation step. FIG. 7A is a schematic perspective view illustrating an example of the configuration of the porous material according to a modified example for FIG. 1 disclosed in the embodiment described later, which is the porous carbon material obtained after the separation step, and FIG. 7B is a schematic sectional view taken along the line E-E of the perspective view.

In the separation step, for example, inorganic acid such as hydrofluoric acid, hydrochloric acid, sulfuric acid, nitric acid, phosphoric acid, or boric acid, organic acid having a carboxyl group, a hydroxyl group, a thiol group, alkenol structure, or the like in a molecule, or a mixture thereof is used. When a template formed of alkali earth metal is used as the porous template 20, the porous template is dissolved with acid not containing hydrofluoric acid. It is desirable not to use hydrofluoric acid because of concerns about safety, environmental load, and cost. It is possible to avoid the use of hydrofluoric acid by using a template formed of alkali earth metal that is dissolvable with acid other than hydrofluoric acid, such as hydrochloric acid or sulfuric acid.

Further, in general, since acid containing fluorine, such as hydrofluoric acid, forms a hardly soluble compound with alkali earth metal contained in an alkali earth metal oxide, a compound that is hardly soluble in an aqueous medium is formed in a dissolving process of the alkali earth metal oxide. In contrast, the use of acid not containing fluorine makes it possible to form a compound that does not form an insoluble salt and is easily dissolved in an aqueous medium. That is, according to the present embodiment, the use of acid not containing hydrofluoric acid allows the porous template to be easily dissolved when alkali earth metal oxide forming the porous template, in particular, magnesium oxide or calcium oxide is employed as a template. Herein, “dissolved” means that, when a template and an aqueous medium acid are brought into contact, a clear, transparent, and uniform liquid is finally formed without any insoluble compounds remaining in an aqueous medium.

In the separation step, for example, the amount of acid used for separating the molding 30 from the porous template 20 is 1 time or greater relative to the amount of the porous template, preferably 1.2 times or greater in the stoichiometric ratio. In the separation step, for example, the temperature for dissolving the porous template 20 with acid can be a range of 5 to 100° C. In the separation step, for example, stirring operation, vibration operation, or the like may be performed on the acid mixed with the porous template.

In the separation step, for example, the porous carbon material separated from the porous template 20 is collected by filtration and then dried by vacuum heating and drying, and thereby the porous carbon material is produced. For example, the collection of the porous carbon material may be performed by suction filtration. For example, the vacuum heating and drying for obtaining the porous carbon material can be performed under conditions of a temperature at 100 to 200° C. for 1 to 10 hours. It is preferable to perform substitution with a solvent having small surface tension, such as acetone or alcohols, after performing suction filtration, in terms of avoidance of capillary contraction of the porous carbon material due to vacuum heating and drying. The porous carbon material obtained by this step is a CMS described later in detail. When the GMS according to the embodiment described above is manufactured, the stabilization step is subsequently performed by using this porous carbon material as a precursor. The degree of capillary contraction depends on the shape and the size of the porous carbon material, and contraction to around a half may occur in some cases.

The shape and the size of the porous carbon material obtained after the separation step correspond to the shape and the size of the porous template 20. Specifically, the shape of the GMS 100A corresponds to the shape and the size of the carbon layer 35 coated on the surface of the porous template 20, and the shape of the carbon layer 35 is a shape reflecting the surface shape of the porous template 20, for example. In the separation step, since the capillary contraction occurs due to the acid used, the size of the obtained porous carbon material is smaller than that of the carbon layer 35 coated on the surface of the porous template 20.

### Stabilization Step

Next, after the separation step, heat treatment is performed on the molding separated from the porous template 20 by the separation step. In the stabilization step, for example, the heat treatment on the molding can be performed at 900 to 2000° C. for 0.1 to 5 hours. The heat treatment on the molding in the stabilization step is preferably performed at 1600 to 1800° C. for 0.5 to 2 hours.

The GMS 100A as illustrated in FIGS. 1A and 1B is obtained by the stabilization step. The heat treatment is performed on the molding made of the carbon layer separated from the porous template 20, and thereby the carbon layer can be stabilized. Specifically, the graphene domain size in the porous carbon material can be increased by the above heat treatment, and the amount of edge site can be reduced. When a porous carbon material with a small quantity of edge sites is applied to electrodes of electric double-layer capacitors (EDLC), the electrolyte liquid is less likely to be decomposed even when a high voltage is applied, and thus a high voltage can be applied thereto. Therefore, the energy density can be further improved, and the reliability can also be improved.

According to the manufacturing method of the porous carbon material of the present embodiment, the coating step of coating, with a carbon layer, a porous template in which the primary particle diameter is 300 nm or greater and 30 μm or less to obtain a molding and the separation step of dissolving the porous template with acid to separate the molding from the porous template are provided, thereby a plurality of pores resulted from the shape of the primary particle of the porous template are provided inside the primary particle, and a porous carbon material having a graphene framework in which the particle diameter of the primary particle is 300 nm or greater and 30 μm or less can be produced. Further, according to the porous carbon material of the present embodiment, because a plurality of pores are provided inside the primary particle forming the porous carbon material having a graphene framework, and the particle diameter of the primary particle is 300 nm or greater and 30 μm or less, the diffusion resistance can be reduced, and the rate characteristic when used as an energy storage device can be improved. That is, according to the present embodiment, the use of the porous carbon material according to the present embodiment can realize a device that maintains a high energy density and improves the rate characteristic. One of the significant factors for the reduction in the diffusion resistance described above is that the conduction path can be increased due to the structure resulted from the shape of the porous template.

Further, in the GMS 100A, the primary particles each have a plate-like shape, which reduces interaction between the primary particles and makes it difficult for the primary particles to aggregate. Further, even when such aggregation occurs, the aggregated GMS 100A is fragile against external force in the in-plane direction, and the aggregation is easily eliminated by ultrasonic dispersion or the like.

The porous carbon material of the present invention is not limited to the GMS 100A according to the embodiment described above, and various changes are possible within the scope of the spirit of the claims. For example, the porous carbon material may be a CMS 100B as illustrated in FIGS. 7A and 7B. FIG. 7A is a schematic perspective view illustrating an example of the configuration of the porous material according to a modified example for FIGS. 1A and 1B, and FIG. 7B is a schematic sectional view taken along the line E-E of the perspective view. In the present embodiment, the porous carbon material illustrated in FIG. 7A and FIG. 7B is referred to as carbon mesosponge (CMS). The CMS has a smaller mesh surface (basal surface) size than the GMS, and the size is around 10 nm, for example.

For example, the pore diameter da of the CMS 100B is smaller than the average framework thickness d of the porous template 20. The fact that pore diameter da of the porous carbon material, which is manufactured via a process of coating of the surface of the porous template 20, is smaller than the average framework thickness d of the porous template 20 is mainly caused by the capillary contraction described above that occurs when the porous carbon material is separated from the porous template 20. The ratio da/d of the size of the pore diameter da of the porous carbon material relative to the size of the average framework thickness d of the porous template is, for example, 0.1 to 1.0 or may be 0.1 to 0.8 in some cases.

The particle diameter of the primary particle 10B of the CMS 100B is substantially the same as the particle diameter of the primary particle 10A of the GMS 100A. The specific surface area of the CMS 100B may be the same as or may be different from the specific surface area of the GMS 100A and is, for example, preferably 700 to 2400 (m²/g), more preferably 1700 to 2400 (m²/g).

The GMS 100A according to the above embodiment and the CMS 100B according to the present embodiment can be distinguished from each other by, for example, X-ray diffraction (XRD) and Raman spectroscopy. Specifically, in the XRD measurement, the 10-peak near 2θ=43° and the 11-peak near 2θ=780 resulted from the graphene sheet structure appear stronger in the GMS than in the CMS. Further, in the Raman spectroscopy, the intensity of the 2D-band is higher in the GMS than in the CMS.

Even with the CMS, because a plurality of pores P are provided inside the primary particle 10B forming the CMS 100B having a graphene framework, and the particle diameter of the primary particle 10B is 300 nm or greater and 30 μm or less, an energy storage device with a high rate characteristic can be realized.

The porous carbon material according to the above embodiment can be applied to a wide variety of applications such as adsorption agents, various catalysts alone, electrode materials and conductive agents of electric double-layer capacitors or rechargeable batteries, or the like.

When a carbon material is taken out of a capacitor, a layer facing a current collector and having a high carbon content is peeled by using a spatula. For example, this layer includes the carbon material, a conductive agent, and a binder. To take out the carbon material from this layer, first, the layer is washed with the same solvent as used for an electrolyte liquid to remove the electrolyte. When a solvent that can dissolve the binder used for producing the electrode is available, the layer is further washed with this solvent. The solid components are then collected to determine that the carbon material contains the GMS according to the present embodiment.

Specifically, the presence of the mesoporous structure characteristic of the GMS and the CMS is determined by observing powder by using TEM. Next, the powder is gradually heated, and it is determined whether or not the GMS is contained. It has been confirmed in Examples that the GMS is desorbed at about 700° C. in thermogravimetric analysis under air circulation, and the GMS has the second highest desorption temperature next to HOPG among carbon materials. The HOPG does not have the mesoporous structure. Therefore, by heating powder containing the carbon material up to 680° C., it is possible to determine that the carbon material remaining without being desorbed is the GMS.

The primary particles of the GMS are obtained by mixing the left carbon material with ethanol, which is an organic solvent, and performing ultrasonic dispersion thereon. The ultrasonic dispersion is performed by using an ultrasonic disperser for 30 minutes and then using a homogenizer for 30 minutes. The primary particle diameter of the GMS is determined by observing the dispersed powder by SEM, measuring the in-plane direction length of 100 primary particles in a SEM image at a magnification of 30,000, and averaging the measured in-plane direction lengths. Further, the particle size distribution can be measured by a laser diffraction method or the like.

Next, a lithium-ion rechargeable battery that is an energy storage device of the present invention will be described.

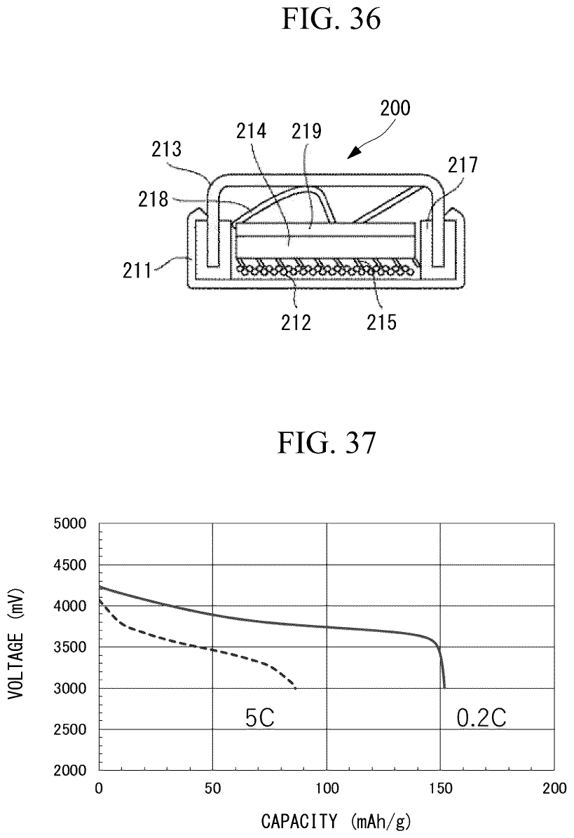

FIG. 36 illustrates an example of a sectional structure of an energy storage device 200 according to one embodiment of the present invention as a coin cell lithium-ion battery. This lithium-ion battery has a disk-like cathode 212 accommodated in a metal exterior component 211 and a disk-like anode 214 accommodated in a metal exterior component 213 stacked together via a separator 215 therebetween. Note that a metal spring 218 and a spacer 219 are arranged between the exterior component 213 and the anode 214. The exterior component 211 and the exterior component 213 are filled with a liquid electrolyte, and peripheral edges of the exterior component 211 and the exterior component 213 are sealed by crimping via a sealing gasket 217.

The cathode will be described.

For example, the cathode 212 is obtained by applying slurry made of a mixture of a metal oxide-based material, a conductive agent for assisting electronic conductivity, a binder, and a solvent onto a current collecting metal foil such as a rolled aluminum foil, thereby forming a coated film, heating and drying the coated film to remove the solvent, and then forming the coated film into predetermined dimension and density.

A metal compound-based material that can be used for a cathode active material is a material that can release electrons to an external circuit of the battery and release Li ions to an electrolyte at the same time. While the amount of contained Li ions varies in accordance with the chemical composition, crystal structure, or the like thereof, it is preferable to use a material that can reversibly take in and out a large amount of Li ions.

Examples of the material may be transition metal oxides, composite oxides of lithium and transition metals, transition metal sulfides, or the like. As the transition metal, Fe, Co, Ni, Mn, or the like are used. Specific examples may be transition metal oxides such as MnO, V₂O₅, V₆O₁₃, TiO₂, and inorganic compounds such as LiNiO₂, LiCoO₂, LiMn₂O₄, and TiS₂, FeS, and MoS₂. To improve their characteristics, transition metal oxides in which a particular element thereof is partially substituted with a certain element may be used.

In addition to the inorganic compounds described above, cathode materials made of organic compounds can be also used. For example, polyaniline, polypyrrole, polyacene, disulfide-based compounds, polysulfide-based compounds, N-fluoropyridinium salts, or the like may be used. The cathode materials may be a mixture of the inorganic compounds and the organic compounds described above.

The physical properties of the cathode material are determined from requirement items for battery design and manufacturing process due to constraint conditions such as a usage form of the energy storage device. In manufacturing of the cathode material, process design or the like have been made to be able to achieve desired physical properties thereof. Examples of physical property values may be powder particle diameter and distribution, a specific surface area, a density, or the like.

As an example, the powder particle diameter is selected as appropriate under consideration on other composition requirements of the energy storage device, and is typically, preferably 1 to 30 μm, more preferably 1 to 10 μm as an average value in terms of improvement in battery characteristics such as rate characteristics or cycle characteristics.

Since the cathode materials described above have generally low electron conductivity, it is preferable that a conductive agent for assisting the electron conductivity coexist within the cathode. As a material of the conductive agent, carbon-based materials and metal-based materials as well as other materials having high electron conductivity can be used, and the carbon-based materials are suitable among these materials.

The amount of the conductive agent to coexist has to be the minimum necessary, and the content of the cathode material that defines the capacity of the energy storage device has to be increased to the maximum.

Conventional carbon-based materials are soot, acetylene black, Ketjen black, lamp black, furnace black, carbon black, graphite, carbon fiber, graphite fiber, nanofiber, nanotube, coke, hard carbon, amorphous carbon, or the like.

Compared to the above, the conductive agent of the present embodiment has significant features that are not seen in the conventional materials, as described above. That is, the conductive agent of the present embodiment has elasticity against stress while having a nanocarbon-like microstructure and has a small number of oxygen-containing functional groups for its high specific surface area.

Since the conductive agent has such features, the electron conductivity of the electrode can be maintained even in an electrochemical oxidation environment or a stress environment experienced by the conductive agent within a battery, and deterioration of the characteristics can be suppressed.

While varying in accordance with a difference in a type of the cathode material, a type and an amount of a binder, battery capacity design, or the like, the ratio suitable for containing the conductive agent made of the porous carbon material of the present embodiment in the cathode is preferably 0.03 wt % or higher in the cathode mixture.

The cathode material and the conductive agent described above are often in a powder form, and to fix particles of the powder to each other and onto the current collecting metal foil, it is preferable to mix a small amount of a binder. The binder is required to be chemically and electrochemically inert and have some flexibility and affinity, and plastic resin materials are suitably used.

The plastic resin material described above may be, for example, fluorine-based resin such as polyvinyl fluoride, polyvinylidene fluoride, and polytetrafluoroethylene, CN group-containing polymers such as polyacrylonitrile and polyvinylidene cyanide, polyvinyl alcohol-based polymers such as polyvinyl acetate and polyvinyl alcohol, halogen containing polymers such as polyvinyl chloride and polyvinylidene chloride, conductive polymers such as polyaniline, alkane-based polymers such as polyethylene, polypropylene, and poly-1,1-dimethylethylene, unsaturated polymers such as polybutadiene and polyisoprene, polymers with rings such as polystyrene, polymethylstyrene, polyvinylpyridine, and poly-N-vinylpyrrolidone, acrylic polymers such as polymethyl methacrylate, polyethyl methacrylate, polybutyl methacrylate, polymethyl acrylate, polyethyl acrylate, polyacrylic acid, polymethacrylic acid, and polyacrylamide. Further, the plastic resin material may be mixtures, modified products, derivatives, random copolymers, alternating copolymers, graft copolymers, block copolymers, or the like of the resin materials described above. The weight-average molecular weight of these resins is typically 10,000 to 3,000,000, and preferably 100,000 to 1,000,000. An excessively small molecular weight reduces the strength of the coated film, and an excessively large molecular weight increases the viscosity and makes it difficult to form the electrode.

To sufficiently uniformly distribute the binder and to form the slurry to be a coated film having a predetermined dimension, a suitable slurry solvent that dissolves only the binder resin and does not dissolve other materials can be used. For example, when polyvinylidene fluoride is used, dimethylformamide is suitably used as the solvent. Alternatively, N-methylpyrrolidone may be used as the solvent, and can be selected as appropriate in accordance with the conditions of the manufacturing process.

As the current collecting metal foil, materials that are inexpensively available and durable for industrial use are preferred, and materials having electrochemically resistance to a potential developed by the cathode are suitably used. As an example of the current collecting metal foil, aluminum foils, nickel foils, titanium foils, and stainless-steel foils are preferred, and rolled aluminum foils that are easily available in general are more preferred.

As a coated film forming method of the slurry described above, commonly used printing techniques can be used. When the thickness dimension of the coated film is small, printing methods such as gravure printing are suitably used, and when the thickness dimension of the coated film is large, printing methods such as doctor blade printing or die printing are suitably used.

The coated film is then heated and dried. Any drying method can be used, and methods that can achieve a desired binding strength in accordance with a binder are suitably used.

Further, when the cathode is then formed into a predetermined dimension, an industrially available cutting blade or the like and the system thereof are suitably used. Further, to achieve a predetermined density, an industrially available pressurizing device or the like and the system thereof are suitably used if necessary.

Next, the anode will be described.

For example, the anode 214 is obtained by coating a current collecting metal foil such as rolled copper foil with slurry made of a mixture of a carbon-based material, a binder, and a solvent, heating and drying the coated material to remove the solvent, and then forming the coated material into predetermined dimension and density.

As the carbon-based materials that can be used for the anode, a material that can bind and stabilize Li ions with electrons flowing in from an external circuit and has a large number of stabilizing sites inside is preferred.

For example, any material originating from an organic substance with high or low crystallinity can be used, and graphite, coke, amorphous carbon, hard carbon, polymer carbon, or the like can be suitably used. In such a case, the principle is that Li ions are held between graphene layers or the like, bound with electrons in this state, and stabilized.

Further, as another stabilizing mechanism, a method of electrochemically forming an intermetallic compound can also be used, and silicon, tin, zinc, bismuth, antimony, cadmium, lead, germanium, or the like can be suitably used.

In addition, other materials exhibiting low electrochemical reaction potentials can also be used to serve as the anode side of the energy storage device. Preferably, the materials may be compounds of metals and oxygen, sulfur, halogen, nitrogen, phosphorus, or the like.

Further, to obtain a particular discharge profile for some use of the energy storage device, a plurality of anode materials described above can be mixed at a predetermined ratio, and the mixture can be used.

The physical properties of the anode material are determined from requirement items for design of an energy storage device (for example, a storage battery) and manufacturing process due to constraint conditions such as a usage form of the energy storage device. In manufacturing of the materials thereof, process design or the like have been made to be able to achieve desired physical properties thereof. Physical property values may be powder particle diameter and distribution, a specific surface area, a density, or the like.

As an example, the powder particle diameter is selected as appropriate under consideration on other composition requirements of the energy storage device, and is typically, preferably 1 to 70 μm, more preferably 3 to 30 μm as an average value in terms of improvement in battery characteristics such as rate characteristics or cycle characteristics.

Although the anode materials described above have generally high electron conductivity, some materials have smooth surfaces, and when contact between particles is insufficient, it is also preferable that a conductive agent for assisting the electron conductivity coexist. As a material thereof, carbon-based materials and metal-based materials as well as other materials having high electron conductivity can be used, and the carbon-based materials are suitable among these materials.

The amount of the conductive agent to coexist has to be the minimum necessary, and the content of the anode material that defines the capacity of the energy storage device has to be increased to the maximum.

Conventional carbon-based materials are soot, acetylene black, Ketjen black, lamp black, furnace black, carbon black, graphite, carbon fiber, graphite fiber, nanofiber, nanotube, coke, hard carbon, amorphous carbon, or the like.

Compared to the above, the conductive agent of the present embodiment has significant features that are not seen in the conventional materials, as described above. That is, the conductive agent of the present embodiment has elasticity against stress while having a nanocarbon-like microstructure and has a small number of oxygen-containing functional groups for its high specific surface area.

Since the conductive agent has such features, the electron conductivity of the electrode can be maintained even in an electrochemical reduction environment or a stress environment experienced by the conductive agent within a battery, and deterioration of the characteristics can be suppressed.

The ratio suitable for containing the conductive agent made of the porous carbon material of the present invention in the anode is preferably 0.03 wt % or higher per the anode mixture while varying in accordance with a difference in a type of the anode material, a type and an amount of a binder, battery capacity design, or the like

As the current collecting metal foil, materials that are inexpensively available and durable for industrial use are preferred, and materials not having electrochemically reactivity to a potential developed by the anode are suitably used. As an example of the current collecting metal foil, copper foils, nickel foils, titanium foils, and stainless-steel foils are preferred, and electrolytic copper foils and rolled copper foils that are easily available in general are more preferred.

As a coated film forming method of the slurry described above, commonly used printing techniques can be used. When the thickness dimension is small, printing methods such as gravure printing are suitably used, and when the thickness dimension is large, printing methods such as doctor blade printing or die printing are suitably used.

The coated film is then heated and dried. Any drying method can be used, and methods that can achieve a desired binding strength in accordance with a binder are suitably used.

Further, when the anode is then formed into a predetermined dimension, an industrially available cutting blade or the like and the system thereof are suitably used. Further, to achieve a predetermined density, an industrially available pressurizing device or the like and the system thereof are suitably used if necessary.

The anode material and the conductive agent described above are often in a powder form, and to fix particles of the powder to each other and onto the current collecting metal foil, it is preferable to mix a small amount of binder. The binder is required to be chemically and electrochemically inert and have some flexibility and affinity, and plastic resin materials are suitably used.

The plastic resin material described above may be, for example, fluorine-based resin such as polyvinyl fluoride, polyvinylidene fluoride, and polytetrafluoroethylene, CN group-containing polymers such as polyacrylonitrile and polyvinylidene cyanide, polyvinyl alcohol-based polymers such as polyvinyl acetate and polyvinyl alcohol, halogen containing polymers such as polyvinyl chloride and polyvinylidene chloride, conductive polymers such as polyaniline, alkane-based polymers such as polyethylene, polypropylene, and poly-1,1-dimethylethylene, unsaturated polymers such as polybutadiene and polyisoprene, polymers with rings such as polystyrene, polymethylstyrene, polyvinylpyridine, and poly-N-vinylpyrrolidone, acrylic polymers such as polymethyl methacrylate, polyethyl methacrylate, polybutyl methacrylate, polymethyl acrylate, polyethyl acrylate, polyacrylic acid, polymethacrylic acid, polyacrylamide, carboxymethyl cellulose, styrene butadiene rubber, or the like. Further, the plastic resin material may be mixtures, modified products, derivatives, random copolymers, alternating copolymers, graft copolymers, block copolymers, or the like of the resin materials described above. The weight-average molecular weight of these resins is typically 10,000 to 3,000,000, preferably 100,000 to 1,000,000. An excessively small molecular weight reduces the strength of the coated film, and an excessively large molecular weight increases the viscosity and makes it difficult to form the electrode.

To sufficiently uniformly distribute the binder and to form the slurry to be a coated film having a predetermined dimension, a suitable slurry solvent that dissolves only the binder resin and does not dissolve other materials can be used. For example, when polyvinylidene fluoride is used, dimethylformamide is suitably used as the solvent. Alternatively, N-methylpyrrolidone may be used as the solvent, and can be selected as appropriate in accordance with the conditions of the manufacturing process.

The electrolyte for the battery of the present invention will be described.

The electrolyte is obtained by dissolving a solute in an organic solvent, and typically, the solute and the organic solvent are the main components.

One of the compositions of the electrolyte is primarily a solute that is a source of ions, that is, a Li salt.

The type of the solute is not particularly limited, and any solute can be used as long as it is known to be utilized for the use of such an energy storage device. Specifically, the following can be used.

Examples of the solute may be inorganic salt such as LiPF₆ and LiBF₄, fluorine-containing organic Li salt such as LiCF₃SO₃, LiN(CF₃SO₂)₂, LiN(C₂F₅SO₂)₂, Li cyclic 1,2-perfluoroethane disulfonylimide, Li cyclic 1,3-perfluoropropane disulfonylimide, LiN(CF₃SO₂)(C₄F₉SO₂), LiC(CF₃SO₂)₃, LiPF₄(CF₃)₂, LiPF₄(C₂F₅)₂, LiPF₄(CF₃SO₂)₂, LiPF₄(C₂F₅SO₂)₂, LiBF₂(CF₃)₂, LiBF₂(C₂F₅)₂, LiBF₂(CF₃SO₂)₂, and LiBF₂(C₂F₅SO₂)₂, Li bis(oxalate) borate, or the like.

Among the above, LiPF₆, LiBF₄, LiN(CF₃SO₂)₂, and LiN(C₂F₅SO₂)₂ are preferred in terms of exerting battery performance, and LiPF₆ and LiBF₄ are particularly preferred.

Note that these Li salts may be used alone, or two or more of these Li salts may be used in combination.

The content ratio of Li salt in the electrolyte will vary in accordance with the type of the solvent used to dissolve the Li salt or the mixture composition thereof. The content ratio of Li salt in the electrolyte is preferably 7 to 190% by weight, more preferably 10 to 180% by weight, still more preferably 13 to 150% by weight.

Next, organic solvents used for the electrolyte will be described.

The type of the organic solvent is not particularly limited, and the organic solvent can be selected as appropriate from those conventionally known as solvents. For example, cyclic carbonates, chain carbonates, cyclic ethers, chain ethers, cyclic carboxylic acid esters, chain carboxylic acid esters, phosphorus-containing organic solvents, or the like having no unsaturated bond may be used.

Factors that affect the migration of Li ions may be the viscosity and the solvation ability of the organic solvent. The solvation ability is the force to dissociate dissolved ions, and since an excessively strong solvation ability inhibits the migration of ions, there is an optimum value.

Further, the operating environment conditions for practical energy storage devices are of a wide range, and in particular, the physical properties of the organic solvent, such as the melting point or the boiling point, are also required to be included within a certain range.

A practical solution to the above requirements is to use a mixture of multiple organic solvents. The mixture composition thereof is determined by taking practical characteristics into consideration from combinations of physical properties such as the organic solvent having a high melting point and the organic solvent having a low melting point, the organic solvent having a high solvation ability and the organic solvent having a low solvation ability, or the like.

In the electrolyte of the present embodiment, it is preferable to mix cyclic carbonates and chain carbonates, both of which do not have carbon-carbon unsaturated bonds.

The cyclic carbonate may be alkylene carbonates having an alkylene group having 2 to 4 carbon atoms, such as ethylene carbonate, propylene carbonate, or butylene carbonate. Among these cyclic carbonates, ethylene carbonate and propylene carbonate are preferred in terms of improvement in battery characteristics, and ethylene carbonate is particularly preferred.

As the chain carbonates, dialkyl carbonate is preferred, and the number of carbon atoms in the constituent alkyl groups is preferably 1 to 5, particularly preferably 1 to 4. Specifically, for example, dialkyl carbonate such as symmetrical chain alkyl carbonates such as dimethyl carbonate, diethyl carbonate, or di-n-propyl carbonate; or asymmetric chain alkyl carbonates such as ethylmethyl carbonate, methyl-n-propyl carbonate, or ethyl-n-propyl carbonate may be used. Among these chain carbonates, dimethyl carbonate is preferred because the viscosity thereof is the lowest.

However, since dimethyl carbonate has a slightly lower boiling point, more suitable characteristics can be obtained by further mixing chain carbonates having a higher boiling point. Although diethyl carbonate is preferred for the chain carbonate to be mixed, other chain carbonates can also be used without any problems.

The mixing ratio also varies in accordance with desired practical characteristics. There is an optimum composition for the ratio of chain carbonate to cyclic carbonate, including the ratio of Li salt.

The content ratio of cyclic carbonate in the electrolyte is preferably 1 to 35% by weight, more preferably 3 to 30% by weight, still more preferably 4 to 25% by weight. A plurality of cyclic carbonates can be mixed.

On the other hand, the content ratio of chain carbonate in the electrolyte is preferably 40 to 70% by weight, more preferably 43 to 68% by weight. A plurality of chain carbonates can be mixed.

The following combinations are suitable as the overall composition.

Among combinations of ethylene carbonate and dialkyl carbonates, ethylene carbonate and dimethyl carbonate are preferred, and may further contain a symmetric chain dialkyl carbonate and/or an asymmetric chain dialkyl carbonates. For example, the combination containing ethylene carbonate, symmetrical chain dialkyl carbonates, and asymmetric chain dialkyl carbonates such as ethylene carbonate, dimethyl carbonate and diethyl carbonate, ethylene carbonate, dimethyl carbonate and ethyl methyl carbonate, ethylene carbonate, dimethyl carbonate, diethyl carbonate, and ethyl methyl carbonate is preferred because of a good balance between cycle characteristics and high-output discharge characteristics. Among the above, the asymmetric chain dialkyl carbonate is preferably ethyl methyl carbonates, and the alkyl group of the alkyl carbonate preferably having 1 to 2 carbon atoms is preferred.

Furthermore, as the solvent that aids in dissociation or migration of ions or the like, cyclic ethers, chain ethers, cyclic carboxylic acid esters, chain carboxylic acid esters, or the like can be added in association with the main organic solvents listed above.

The cyclic ethers may be tetrahydrofuran, 2-methyltetrahydrofuran, or the like, and the chain ethers may be dimethoxyethane, dimethoxymethane, or the like.

The cyclic carboxylic acid esters may be γ-butyrolactone, γ-valerolactone, or the like, and the chain carboxylic acid esters may be, methyl acetate, methyl propionate, ethyl propionate, methyl butyrate, or the like.

Among the above, the chain carboxylic acid esters are particularly suitable.

Furthermore, it is preferable to contain fluorine-containing cyclic carbonate having two or more fluorine atoms in the electrolyte of the present embodiment.

Although the number of fluorine atoms in fluorine-containing cyclic carbonate having two or more fluorine atoms is not particularly limited in the case of fluorinated ethylene carbonate, the lower limit number is typically two or greater, and the upper limit number is typically four or less, preferably three or less.

In the case of fluorinated propylene carbonate, the lower limit number is typically two or greater, and the upper limit number is typically six or less, preferably five or less. In particular, the fluorinated propylene carbonate having two or more fluorine atoms bound to the carbon atoms forming the ring structure is preferred in terms of improvement in cycle characteristics and storage characteristics.

Among the above, fluorinated ethylene carbonate having two or more fluorine atoms is preferred in terms of improvement in battery characteristics, and furthermore, among the above, cis-4,5-difluoro-1,3-dioxolan-2-one, trans-4,5-difluoro-1,3-dioxolan-2-one or 4,4-difluoro-1,3-dioxolan-2-one is particularly preferred.

The fluorine-containing cyclic carbonate having two or more fluorine atoms may be used alone, or two or more types of the fluorine-containing cyclic carbonates may be used in combination. The ratio of the fluorine-containing cyclic carbonate compound having two or more fluorine atoms in the non-aqueous electrolyte is not particularly limited in achieving the effect of the present embodiment, and is typically 0.001% by weight or higher, preferably 0.01% by weight or higher, more preferably 0.1% by weight or higher, particularly preferably 0.2% by weight or higher, most preferably 0.25% by weight or higher. At a concentration lower than the above, it may be difficult to achieve the effect of the present embodiment. On the contrary, since an excessively high concentration may increase the internal pressure of the battery during high-temperature storage, the upper limit is typically 10% by weight or less, preferably 4% by weight or less, more preferably 2% by weight or less, particularly preferably 1% by weight or less, most preferably 0.5% by weight or less.

In addition, cyclic carbonates having unsaturated bonds or aromatic compounds having a total carbon number of 7 or greater and 18 or less may be mixed in the electrolyte.

Among the cyclic carbonates having an unsaturated bond, vinylene carbonate, vinylethylene carbonate, 4-methyl-4-vinylethylene carbonate, or 4,5-divinylethylene carbonate is preferred in terms of improvement in cycle characteristics, and among these cyclic carbonates, vinylene carbonate or vinylethylene carbonate is more preferred. These cyclic carbonates may be used alone, or two or more types of these cyclic carbonates may be used in combination.

As the aromatic compound having a total carbon number of 7 or greater and 18 or less, aromatic compounds such as biphenyl, alkylbiphenyl, terphenyl, partially hydrogenated terphenyl, cyclohexylbenzene, t-butylbenzene, t-amylbenzene, diphenyl ether, dibenzofuran, or the like are preferred.

When side reactions between the aromatic compound having a total carbon number of 7 or greater and 18 or less and the anode and cathode are suppressed in such a way, it is expected that the significant deterioration of discharge characteristics after high-temperature storage can be suppressed.

To achieve the effect of the present embodiment, the ratio of aromatic compound having a total carbon number of 7 or greater and 18 or less in the electrolyte is typically 0.001% by weight or higher, preferably 0.1% by weight or higher, particularly preferably 0.3% by weight or higher, most preferably 0.5% by weight or higher, the upper limit is typically 5% by weight or less, preferably 3% by weight or less, particularly preferably 2% by weight or less. At a concentration lower than this lower limit, it may be difficult to achieve the effect of improving safety during overcharging. On the contrary, an excessively high concentration may reduce the battery characteristics such as high-temperature storage characteristics.

The separator 215 separates the cathode 212 and the anode 214 from each other and allows lithium ions to pass through while preventing a short circuit of current due to contact between the two electrodes, and a porous membrane made of resin is suitably used.

As a membrane form, a stretched membrane in which pores are formed by stretching bulk resin, a nonwoven fabric in which a pore structure like a porous membrane can be created by laminating a large number of fiber-like resin fibers, or the like are suitably used.

The material for the resin may be polyolefins, and polyethylene is particularly suitable. Polyethylene has a relatively low melting temperature, and when the temperature of the battery rises for some reason (for example, an unsafe condition such as a short circuit or the like), the pores in the membrane are closed due to heat fusion, the migration of driving ions is inhibited, thereby the reaction is stopped, and safety can be ensured.

In porous membranes formed by the stretching scheme, typically, a plasticizer or the like are added to polyolefin, the plasticizer is removed before or after the stretching, and the porous membranes have a relatively uniform microporous structure from a portion as a starting point where the plasticizer has been present or the like.

In manufacturing of a stretched membrane, stretching is typically performed in both the longitudinal direction and the width direction. A suitable stretched membrane can be obtained by combining any atmospheric medium, a temperature, a speed, a stress, the number of process repetitions, or the like as appropriate, in addition to the removal of the plasticizer or the like as described above.

Although a high-quality stretched membrane can be obtained through the above manufacturing step, multiple phases of steps are required. This makes it difficult to reduce manufacturing costs such as processing costs, and this may be a negative factor in the spread of energy storage devices.

In contrast, by simplifying steps so that stretching is performed only in the longitudinal direction without using a plasticizer or the like, it is possible to obtain a porous membrane that can be manufactured on an industrial scale and also reduce the manufacturing costs. In such a case, the applicable resin is polyolefin, and polypropylene is suitable used.

The separator interposed between the cathode and the anode can be any separator as long as it is formed of an electrically insulating porous body. As the separator, for example, a membrane or a fibrous nonwoven fabric made of polymer such as a polyolefin such as polyethylene and polypropylene, polyester, polyethylene terephthalate, or polyimide is applicable. As the material of the separator, a single type thereof may be used alone, or multiple types thereof may be used. Further, the separator may be of a single layer or a multilayer (composite membrane). Further, the separator may contain nano-particles of an inorganic material such as ceramic. Further, a high molecular compound such as polyvinylidene fluoride may be applied to both sides of the separator.

In the non-aqueous electrolyte battery according to the present embodiment, an electrolyte in a gel form made by containing a polymer compound that becomes a holder that swells with an organic solvent and retains the non-aqueous electrolyte may be used. This is because, when a polymer compound that swells with an organic solvent is contained, high ionic conductivity can be obtained, excellent charge/discharge efficiency can be obtained, and leakage of the battery can be prevented. When the non-aqueous electrolyte contains a polymer compound, the content of the polymer compound is preferably within a range of 0.1% by weight or greater and 10% by weight or less of the non-aqueous electrolyte.

Further, when a polymer compound such as polyvinylidene fluoride is applied to both sides of the separator, the mass ratio of the non-aqueous electrolyte to the polymer compound is preferably within a range of 50:1 to 10:1. With the mass ratio being within this range, higher charge/discharge efficiency can be obtained.

The above polymer compound may be, for example, ether-based polymer compounds such as polyvinyl formal, polyethylene oxide, and crosslinked products containing polyethylene oxide, ester-based polymer compounds such as polymethacrylate, acrylate-based polymer compounds, and polyvinylidene fluoride, and polymers of vinylidene fluoride such as copolymers of vinylidene fluoride and hexafluoropropylene. A single type of polymer compound may be used alone, or multiple types thereof may be used as a mixture. In particular, in terms of the effect of preventing swelling during high-temperature storage, it is desirable to use a fluorine-based polymer compound such as polyvinylidene fluoride.

The energy storage device having the configuration as described above operates as follows.

When the energy storage device is charged, Li ions contained in the cathode 212 pass through the separator 215 and are inserted between layers of the layered structure of graphite contained in the anode 214. Then, when the energy storage device is discharged, Li ions are released from between the layers of the layered structure included in the anode 214, pass through the separator 215, and return to the cathode 212.

Although the energy storage device according to one embodiment of the present invention has been described above with the lithium-ion battery as an example, the present invention is not limited to the above embodiment, and various modifications are possible within the scope not departing from the spirit of the invention.

Although the coin cell lithium-ion battery has been described as the energy storage device as an example in the above embodiment, the energy storage device of the present embodiment can be similarly applied to batteries having other shapes such as a button type, a paper type, a square type, or a cylindrical type with spiral structure. Further, the energy storage device of the present embodiment can have various sizes such as a thin device or a large device.

Furthermore, although the embodiment assuming the case of the energy storage device having a liquid electrolyte as the electrolyte according to the present embodiment has been described above, any other electrolytes can be applicable, and by way of an example, gel electrolytes or solid electrolytes can also be suitably used.

### EXAMPLES

Examples of the present embodiment will be described below. The present invention is not limited to only the following Examples. First, Examples of the carbon material according to the present embodiment will be described.

### Example 1

### Template

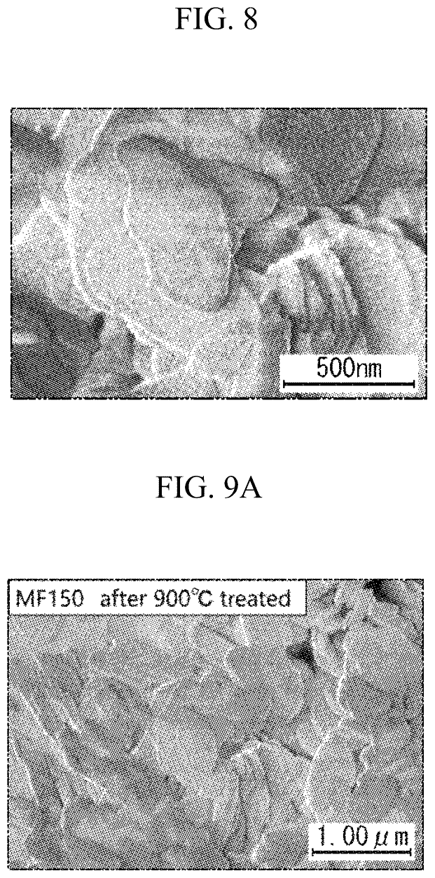

First, Kyowa-mag (registered trademark) MF-150 was prepared as the porous template. Kyowa-mag (registered trademark) MF-150 is powder made of porous bodies formed of magnesium oxide as will be seen in Manufacture example 1 described later. FIG. 8 is an electron microscope image of the porous template used in Example 1. The porous template used in Example 1 has a plurality of primary particles overlapped.

### Heat Treatment Step and Coating Step

The heat treatment step and the coating step were performed by using the prepared porous template to coat the porous template with the carbon layer, and a molding was obtained. In Example 1, first, as the heat treatment step, the temperature was increased up to 900° C. at a rate of temperature rise of 10° C./min under an argon atmosphere, and heat treatment was then performed on the porous template under conditions at 900° C. for 30 minutes. Next, in the coating step, the same device as in the heat treatment step was used, chemical vapor deposition was performed continuously to the heat treatment step by using methane as a source gas at a flow rate of 80 ml/min and argon as a process gas at a flow rate of 320 ml/min under conditions at 900° C. for 2.5 hours, the flow rate of the methane gas was then maintained at 0 ml/min for 30 minutes, and the porous template with the carbon layer was allowed to cool naturally to room temperature.

### Separation Step

Next, 2 g of the molding obtained by the coating step and 100 g of 5 mol/L hydrochloric acid were put into and mixed in a beaker and stirred at 600 rpm at room temperature for 5 hours. The molding separated from the porous template was then taken out and washed with pure water five times while the samples were filtrated by using a membrane filter (0.1 μm), and suction filtration of the molding was performed. Then, with the same scheme as above, the molding and hydrochloric acid were again mixed and stirred, and the suction filtration of the molding was performed by using pure water.

Next, the molding was put into a screw tube bottle including 100 mL of acetone, the lid is closed, and the bottle was well shaken. The bottle was then allowed to stand in a constant temperature dryer at 60° C. overnight. On the next day, the supernatant liquid was discarded, 100 mL of acetone was newly added, and the bottle was allowed to stand at 60° C. for 3 hours in the constant temperature dryer. Next, the supernatant liquid was discarded, 100 mL of acetone was newly added, and the bottle was again allowed to stand at 60° C. for 3 hours in the constant temperature dryer. Then, acetone was removed by suction filtration, the product was dried at 150° C. for 10 hours under reduced pressure of 1000 Pa or less was performed twice by using the constant temperature dryer, and thereby the carbon mesosponge (CMS) that serves as the carbon material was produced.

### Example 2

Example 2 differs from Example 1 in that the stabilization step was performed subsequent to the separation step. Other steps were the same as those in Example 1.

### Stabilization Step

The stabilization step was performed subsequent to the separation step. Specifically, the CMS was placed in a sample chamber of a high-temperature heating furnace (IZU-SMS005, by Izumi Tech), the sample chamber was vacuumed, the temperature was then increased up to 1800° C. at a rate of temperature rise of 15° C./min with a flow of an argon gas at 10 ml/min, and the CMS was sintered by heat treatment at 1800° C. for 1 hour to produce the Graphene MesoSponge® (GMS).

### Manufacture Example 1

Manufacture example 1 refers to a phase of the template of Kyowa-mag (registered trademark) MF-150, which is the porous template used in Example 1.

### Manufacture Example 2

Manufacture example 2 refers to a template at a phase where the heat treatment step was performed on the porous template used in Example 1 under the same conditions as in Example 1. That is, for Kyowa-mag (registered trademark) MF-150, after the temperature was increase up to 900° C. at a rate of temperature rise of 10° C./min under an argon atmosphere, heat treatment was performed on the porous template under conditions at 900° C. for 30 minutes.

### Manufacture Example 3

Manufacture example 3 refers to a product resulted after the heat treatment step and the coating step were performed on the porous template used in Example 1 under the same conditions as in Example 1. That is, after treatment was performed under the same condition as Manufacture example 2, the same device as in the heat treatment step was used, chemical vapor deposition was performed continuously to the heat treatment step by using methane as a source gas at a flow rate of 80 ml/min and argon as a process gas at a flow rate of 320 ml/min under conditions at 900° C. for 2.5 hours, the flow rate of the methane gas was then maintained at 0 ml/min for 30 minutes, and the porous template with the carbon layer was allowed to cool naturally to room temperature.

### Comparative Example 1

As Comparative example 1, a Graphene MesoSponge® (GMS) was produced by the same process as in Example 2 except that alumina nano-particle (product name: SBa-200, by Sasol Chemicals, primary particle diameter: 7 nm) was used as the template and that the template was retained and dissolved with 46% hydrofluoric acid, instead of hydrochloric acid, for 4 hours in the separation step.

### Comparative Example 2

As Comparative example 2, a Graphene MesoSponge® (GMS) was produced by the same process as in Comparative example 1 except that alumina nano-particle (product name: TM-100, by TAIMEI CHEMICALS CO., LTD., primary particle diameter: 14 nm) was used as the template.

### Comparative Example 3

As Comparative example 3, a Graphene MesoSponge® (GMS) was produced by the same process as in Comparative example 1 except that alumina nano-particle (product name: TM-300, by TAIMEI CHEMICALS CO., LTD., primary particle diameter: 7 nm) was used as the template.

The conditions of Manufacture examples 1 to 3, Examples 1 and 2, and Comparative examples 1 to 3 are listed in Table 1 below. MF-150 is a porous template having a primary particle diameter of 300 nm or greater and 30 μm or less.

TABLE 1

| | Manufac- | Manufac- | Manufac- | | | Compar- | Compar- | Compar- |
|---|---|---|---|---|---|---|---|---|
| | ture | ture | ture | Example | Example | ative | ative | ative |
| | example 1 | example 2 | example 3 | 1 | 2 | example 1 | example 2 | example 3 |
| Template | MF150 | MF150 | MF150 | MF150 | MF150 | Secondary | Secondary | Secondary |
| | primary | primary | primary | primary | primary | particle | particle | particle |
| | particle | particle | particle | particle | particle | containing | containing | containing |
| | | | | | | SBa-200 | SBa-200 | SBa-200 |
| Heat | No | Yes | Yes | Yes | Yes | No | No | No |
| treatment | | | | | | | | |
| step | | | | | | | | |
| Coating step | No | No | Yes | Yes | Yes | Yes | Yes | Yes |
| Separation | No | No | No | Yes | Yes | Yes (HF) | Yes (HF) | Yes (HF) |
| step | | | | (HCl) | (HCl) | | | |
| Stabilization | No | No | No | No | Yes | Yes | Yes | Yes |
| step | | | | | | | | |

### Observation by SEM

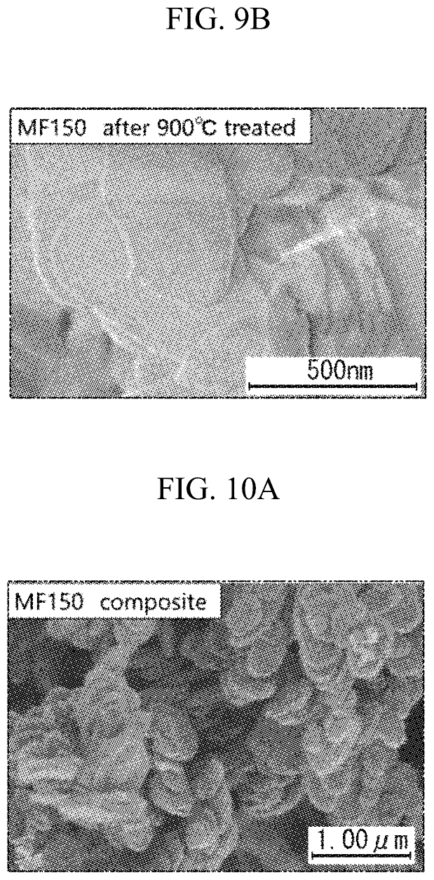

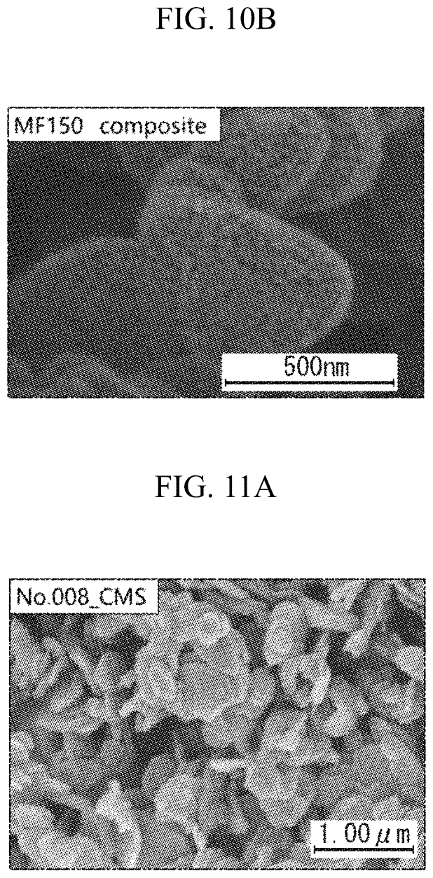

Morphological observation was performed on the porous carbon materials of Example 1 and Example 2, the porous template of Manufacture example 2, the molding of Manufacture example 3, and the carbon material of Comparative example 1 by using a scanning electron microscope. Images of respective samples were taken at the same magnification (×30,000, ×100,000) with an acceleration voltage of 1.0 kV. FIGS. 9A and 9B, FIGS. 10A and 10B, FIGS. 11A and 11B, FIGS. 12A and 12B, and FIG. 13 are SEM images of the porous template of Manufacture example 2, the molding of Manufacture example 3, the porous carbon material of Example 1, the porous carbon material of Example 2, and the carbon material of Comparative example 1, respectively. In FIGS. 9A and 9B to FIGS. 12A and 12B, “A” represents the SEM image at a magnification of 30,000, and “B” represents the SEM image at a magnification of 100,000. It was confirmed from FIGS. 9A and 9B to FIGS. 12A and 12B that, due to the use of the porous template having a plate-like shape, the primary particle of the porous carbon material of a plate-like shape corresponding to the shape of the primary particle of the porous template was formed. On the other hand, in FIG. 13, it is can be seen that the particle diameter is large, a plurality of grains are combined to form a structure, and nano-particles are secondarily aggregated.

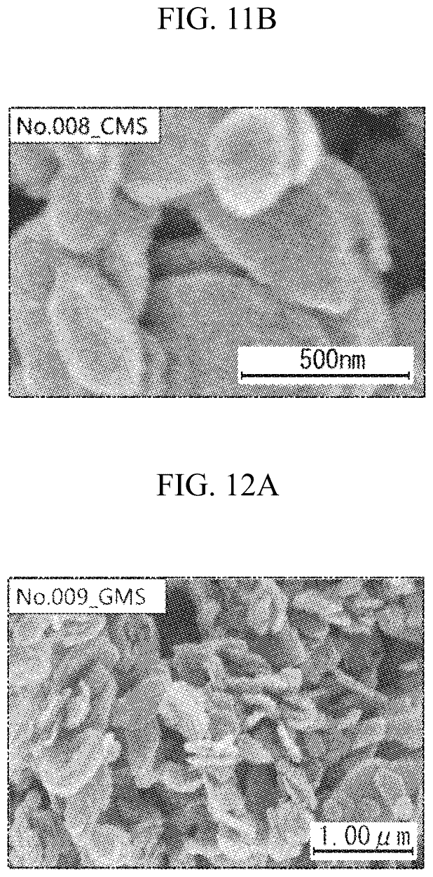

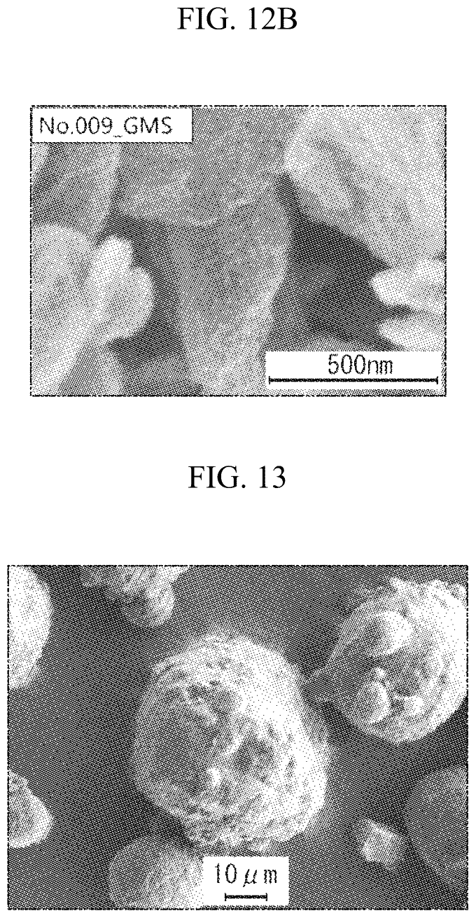

From FIGS. 11A and 11B and FIGS. 12A and 12B, it is possible to identify the primary particle diameter of the porous carbon material. In SEM images at a magnification of 30,000, which is the same as in FIG. 11A and FIG. 12A, 100 porous carbon materials in which an electron beam intersects the primary surface were observed. The longer diameter in the longitudinal direction of the primary surface in FIGS. 11A and 11B was 200 to 1000 nm, the average thereof was 400 nm, the shorter diameter in the shorter direction orthogonal to the longitudinal direction was 150 to 500 nm, and the average thereof was 300 nm. Further, the longer diameter in the longitudinal direction in FIGS. 12A and 12B was 200 to 1000 nm, the average thereof was 400 nm, the shorter diameter in the shorter direction orthogonal to the longitudinal direction was 150 to 500 nm, and the average thereof was 300 nm. That is, the average of the in-plane direction lengths of the primary particles of these porous carbon materials, that is, the primary particle diameters of the porous carbon materials were 400 nm. Further, the thickness of the porous carbon material for which the in-plane direction length was measured was 100 nm in Example 1 and 100 nm in Example 2.

### Observation by TEM

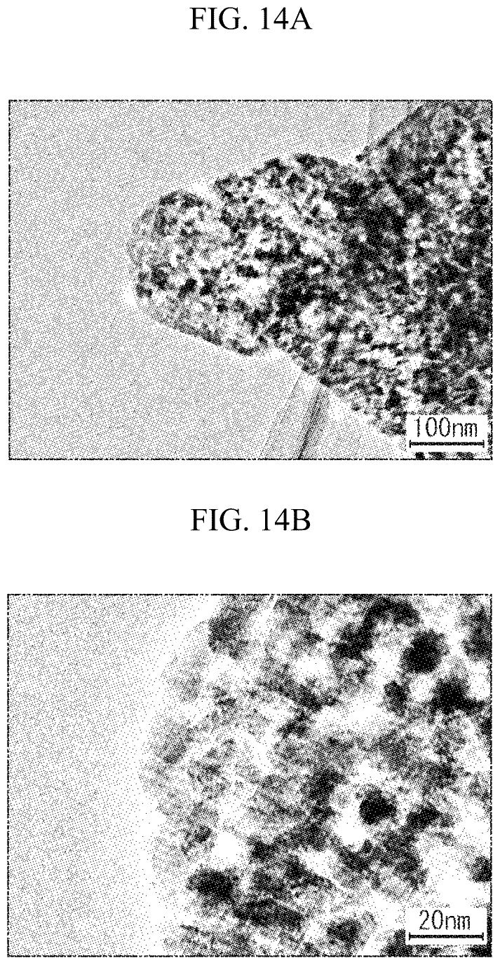

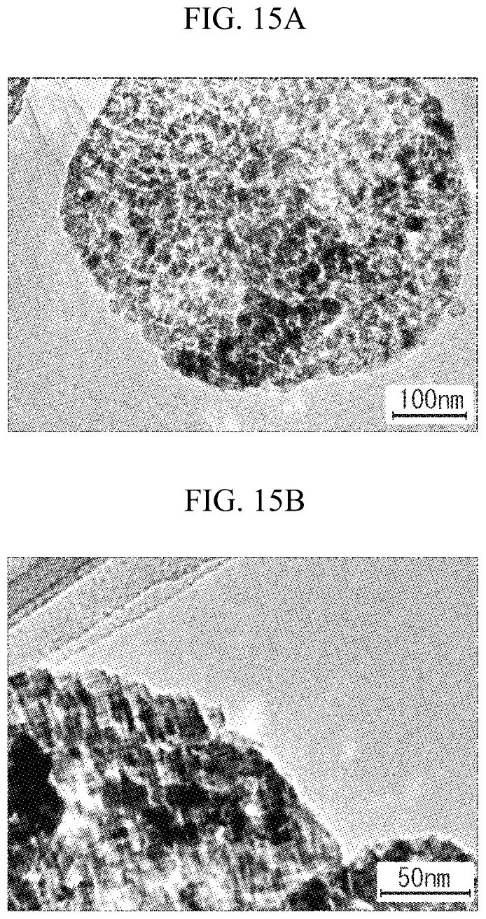

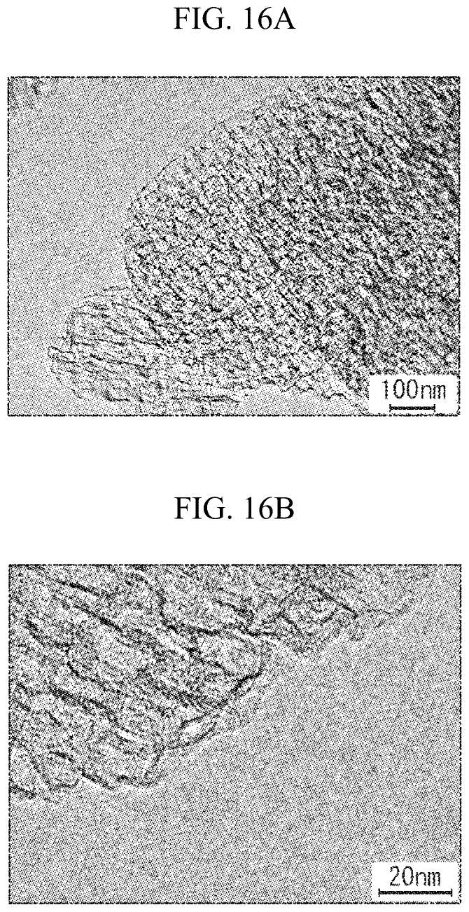

For the porous carbon materials of Example 1 and Example 2, the porous template of Manufacture example 2, and the molding having the porous template of Manufacture example 3 coated with the carbon layer, the shapes thereof were observed by using a transmission electron microscope (JEM-2010 model, JEOL). The porous carbon material was observed using the transmission electron microscope at an acceleration voltage of 200 kV. FIGS. 14A and 14B, FIGS. 15A and 15B, FIGS. 16A and 16B, and FIGS. 17A and 17B represent TEM images of Manufacture example 2, Manufacture example 3, Example 1, and Example 2, respectively.

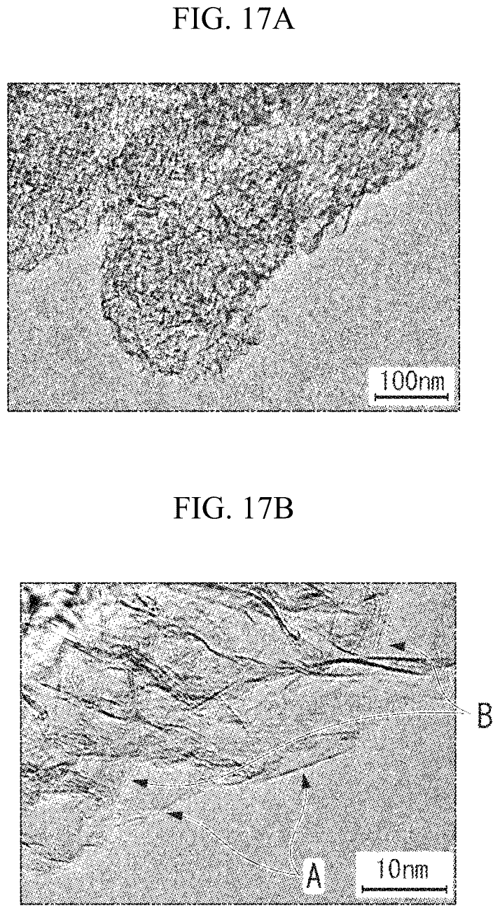

FIG. 17A and FIG. 17B are diagrams obtained when a part near the end of the porous carbon material was observed. In FIG. 17B, a portion that appears to be a single layer is labeled with reference A, and a portion that appears to be multiple layers is labeled with reference B. It can be observed from FIG. 17B that single-layered graphene was formed at the end of the sample, and there are also portions where two or three layers appear to be deposited in some locations.

### Particle Size Distribution

Particle size distribution measurement was performed on the porous carbon materials of Example 1 and Example 2, the porous templates of Manufacture example 1 and Manufacture example 2, and the molding having the porous template of Manufacture example 3 coated with the carbon layer by using a laser diffraction particle size distribution measuring device (MT3300EXII-SDC, by Microtrac Bell, Inc.). Specifically, for each of Manufacture example 1, Manufacture example 2, and Manufacture example 3, ethanol was mixed to a solvent prior to measurement, ultrasonic treatment was performed for 5 minutes by using a three-frequency ultrasonic cleaner (VS-100III, by Azwan Corporation), and particle size distribution measurement was then performed by using the above device. Further, for each of Example 1 and Example 2, ethanol was mixed to a solvent prior to measurement, ultrasonic treatment was performed for 30 minutes by using the three-frequency ultrasonic cleaner (VS-100III, by Azwan Corporation), and particle size distribution measurement was then performed by using the above device. Further, for the porous carbon material of Example 2, after the porous carbon material was produced by the same procedure, a sample (Example 2-B) was also prepared on which dispersion was performed by using the three-frequency ultrasonic cleaner (VS-100III, by Azwan Corporation) for 30 minutes and then using ultrasonic homogenizer (VCX-750, by SONICS) for 10 minutes.

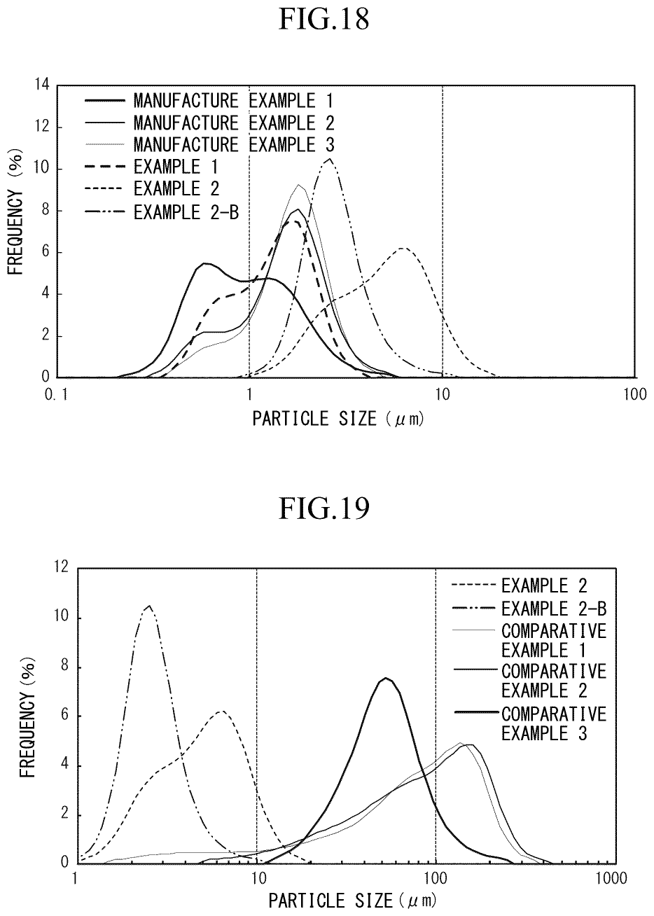

FIG. 18 represents the particle size distribution of the porous carbon materials of Example 1, Example 2, and Example 2-B, the porous templates of Manufacture example 1 and Manufacture example 2, and the molding of Manufacture example 3. As illustrated in FIG. 18, it was seen that the particle size distribution of the porous carbon material was increased compared to the porous template. The particle size distribution of the porous carbon material of Example 1 ranged from about 370 nm to about 4 μm, and the peak thereof was at about 1.6 μm. Further, the particle size distribution of the porous carbon material of Example 2 ranged from about 1 μm to 20 μm, and the peak thereof was at about 6.5 μm. The particle size distribution of Example 2-B ranged from about 0.9 μm to 11 μm, and the peak thereof was at about 2.5 μm. In comparison between Example 2 and Example 2-B, which are the porous carbon materials produced under the same conditions, it is seen that the particle size distribution significantly changes due to dispersion. It was confirmed that, since the porous carbon materials produced in these Examples have a plate-like shape and the interaction between primary particles is small, these particles can be separated even when aggregated during production.

FIG. 19 represents the particle size distribution of the porous carbon materials of Example 2 and Example 2-B and the carbon materials of Comparative example 1 to Comparative example 3. For Comparative example 3, dispersion was performed for 30 minutes by using the ultrasonic homogenizer (VCX-750, by SONICS). It was confirmed from FIG. 19 that the porous carbon materials of Example 2 and Example 2-B have smaller particle size distribution values than the carbon materials of Comparative example 1 to Comparative example 3. Note that the particle size distribution of Comparative example 1 ranged from about 12 μm to 250 μm, and the peak thereof was at about 52 μm. The particle size distribution of Comparative example 2 ranged from about 5 μm to 420 μm, and the peak thereof was at about 150 μm. The particle size distribution of Comparative example 3 ranged from about 1.5 μm to 350 μm, and the peak thereof was at about 135 μm.

The particle diameter of TM-300 used as the template in Comparative example 3 (the diameter of a secondary particle with aggregated nano-particles) is substantially the same as the particle diameter of TM-100 used as the template in Comparative example 2 (the diameter of a secondary particle with aggregated nano-particles). While no ultrasonic dispersion was performed in Comparative example 2, dispersion was performed by the ultrasonic homogenizer in Comparative example 3. However, FIG. 19 indicates a result that the particle size distribution of Comparative example 3 and the particle size distribution of Comparative example 2 are approximately the same. Therefore, it is considered that, unlike in the Examples, aggregation is less likely to be eliminated in the carbon materials as with the Comparative examples.

### XRD Measurement

X-ray diffraction (XRD) measurement was performed on the porous carbon materials of Example 1 and Example 2 and the porous templates of Manufacture example 1 and Manufacture example 2 by using an X-ray diffractometer (Miniflex 600, by Rigaku Corporation). The measurement was performed by using a Si non-reflection plate for a sample table and placing the sample on a circular part. The measurement conditions are listed in Table 2.

TABLE 2

| X-ray source | CuK α | |
|---|---|---|
| Tube voltage | 40 | V |
| Tube current | 15 | mA |
| Measuring angle | 2~90 | deg. |
| Scan speed | 5 | deg./min |

| | |
|---|---|
| Scan axis | 2θ/θ |

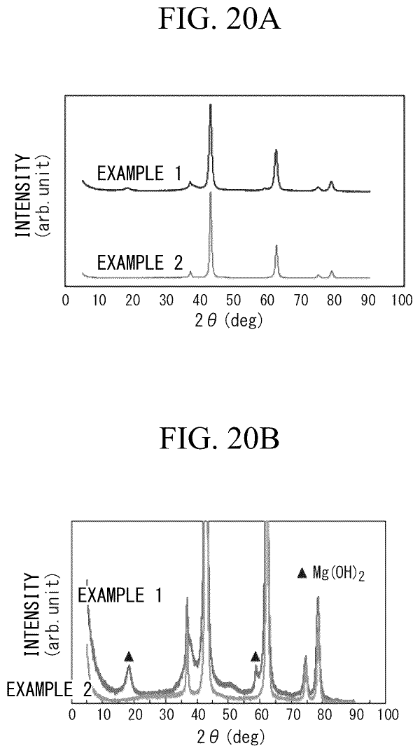

FIGS. 20A and 20B illustrate XRD analysis results on Manufacture example 1 and Manufacture example 2. FIG. 20B illustrates analysis results on Manufacture example 1 and Manufacture example 2 illustrated in FIG. 20A that are overlapped with each other with the scale of the vertical axes being matched. FIG. 20B illustrates peaks of magnesium hydroxide in addition. As indicated in FIGS. 20A and 20B, peaks of magnesium hydroxide not found in the XRD analysis result of Manufacture example 2, which is the porous template resulted after the heat treatment step, were observed in the XRD analysis result of Manufacture example 1, which is the porous template prior to the heat treatment step. Therefore, it is found that magnesium hydroxide is desorbed due to the heat treatment step. The cause for this will be considered in conjunction with a result of TG analysis described later.

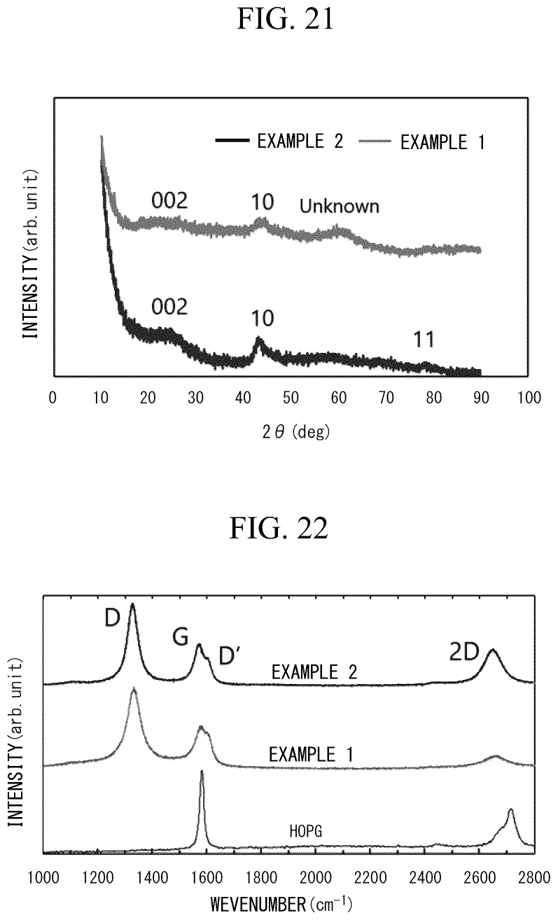

FIG. 21 illustrates XRD analysis results on Example 1 and Example 2. In both Example 1 and Example 2, both the 002-peak around 25° resulted from the lamination structure of graphene and the 10-peak around 430 resulted from the sheet structure of graphene were observed. Therefore, it was confirmed that both the porous carbon materials of Example 1 and Example 2 have a graphene framework. In Example 1 and Example 2, it is considered that the 002-peak is smooth, and no lamination of multiple layers of graphene occurs. Further, in Example 2 subjected to the stabilization step, the intensities of the 10-peak and the 11-peak resulted from the sheet structure of graphene are higher than the intensities of these peaks in Example 1, and it is found that the sheet structure of graphene has grown due to the stabilization step. Note that no 11-peak was seen in Example 1.

### Raman Spectroscopy

For the porous carbon materials of Example 1 and Example 2, the Raman spectrum was measured by a Raman microscope (LabRAM HR-800, by HORIBA, Ltd.). For the measurement, a laser at 532 nm was used, the filter was set to D1, and the hole was set to 100 m. The measurement range was 300 to 3500 cm⁻¹. FIG. 22 illustrates the Raman spectrum of Example 1, Example 2, and HOPG.

In both Example 1 and Example 2, it was confirmed that the D- and D′-bands resulted from a defect such as a non-hexagonal site including an edge site, the G-band resulted from framework vibration of a graphene sheet, and the 2D-band due to second-order phonon scattering are present. The D-band appears as a hexagonal breathing mode at a portion where the symmetry of a hexagon of a graphene domain is collapsed. The D′-band corresponds to a hexagonal bending mode, which is forbidden on an infinitely wide hexagonal mesh surface. Therefore, it was confirmed also from the Raman spectrum that the porous carbon materials of Example 1 and Example 2 have a graphene framework. Further, since the 2D-peak is present on a lower layer side than the 2D-peak of HOPG and can be fitted by a single Lorenz function in both Example 1 and Example 2, it is found that single-layered graphene has grown in Example 1 and Example 2. Note that, in Example 1, the mesh surface size is smaller than in Example 2, and the 2D-peak intensity is thus smaller.

### Nitrogen Adsorption/Desorption Measurement

Nitrogen adsorption/desorption measurement was performed on the porous carbon materials of Example 1 and Example 2, the porous templates of Manufacture example 1 and Manufacture example 2, and the molding having the porous template of Manufacture example 3 coated with the carbon layer by using an automatic specific surface area/pore size distribution measuring device (BEL SORP mini, by Bell Japan Co.). The sample was dried under a reduced pressure at 150° C. for 6 hours by using BEL-pre prior to the measurement.

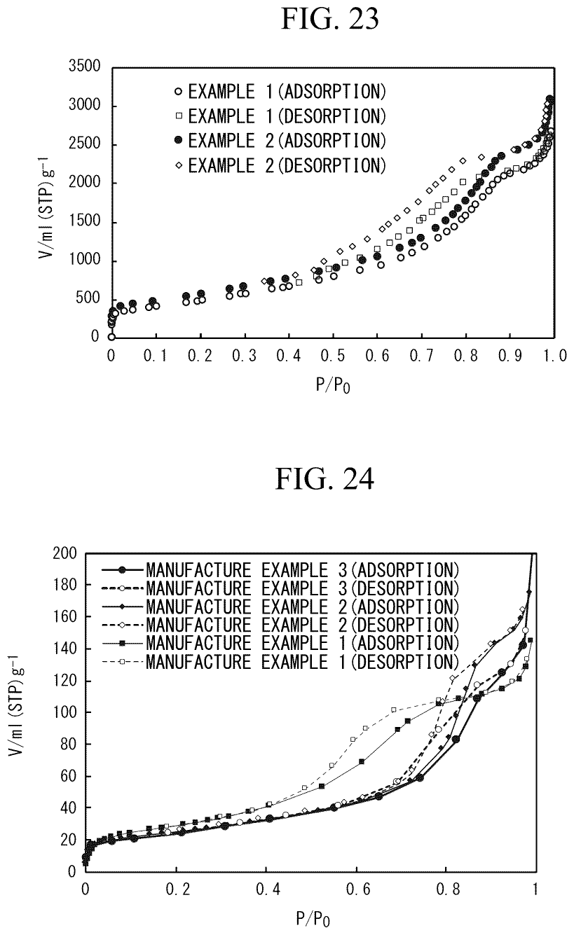

FIG. 23 represents nitrogen adsorption/desorption curves for the porous carbon materials of Example 1 and Example 2. FIG. 24 represents nitrogen adsorption/desorption curves for the porous templates of Manufacture example 1 and Manufacture example 2 and the molding of Manufacture example 3.

From the nitrogen adsorption/desorption isotherms illustrated in FIG. 23, the BET specific surface area was found for the porous carbon materials of Example 1 and Example 2 by using the BET method. The application range of the BET method was P/P₀=0.05 to 0.3. The specific surface areas of the porous carbon materials of Example 1 and Example 2 were 1780 (m²/g) and 2060 (m²/g), respectively. That is, it is confirmed that the specific surface area of the porous carbon material was significantly improved by the stabilization step on the porous carbon material. Further, the specific surface area of Comparative example 1 was measured by the same scheme and was 2010 (m²/g).

For the adsorption/desorption isotherm, the IV-type isotherms having hysteresis were obtained, and therefore, the presence of meso-holes can be confirmed. In both Example 1 and Example 2, a rise of the isotherm can be observed in a region of P/P0≥0.9, and a macro-hole may be present. Further, in the isotherm of Example 2, a rise in the region near P/P0=0.97 is larger than that in Example 1. Thus, it is considered that micro-holes have grown due to sintering.

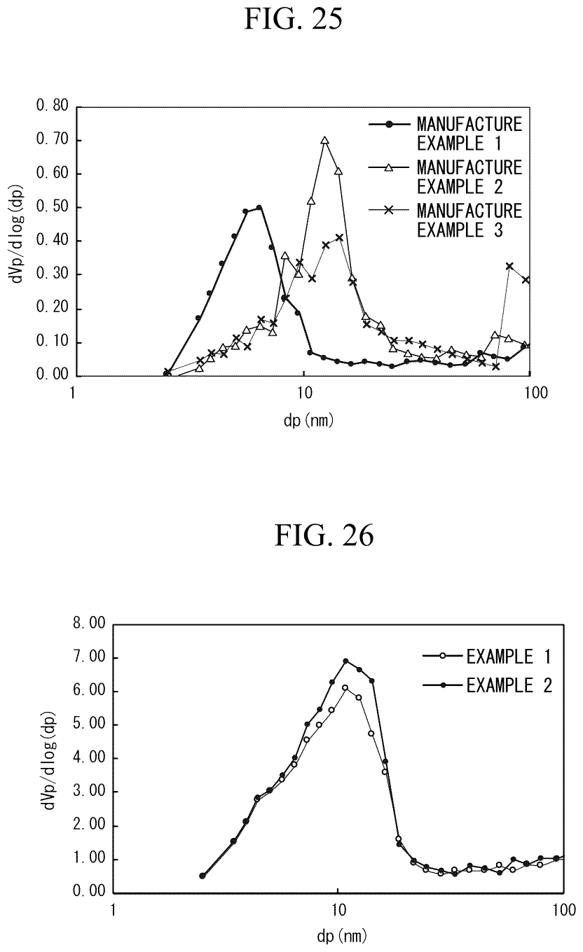

From the nitrogen adsorption/desorption isotherms illustrated in FIG. 23 and FIG. 24, the pore size distribution was found for the porous carbon materials of Example 1 and Example 2, the porous templates of Manufacture example 1 and Manufacture example 2, and the molding of Manufacture example 3 by using the BJH method. A GCB file was applied for the t-file in calculation of pore size distributions. FIG. 25 represents pore size distributions of the porous templates of Manufacture example 1 and Manufacture example 2 and the moldings of Manufacture example 3, and FIG. 26 represents pore size distributions of the porous carbon materials of Example 1 and Example 2.

It can be seen from FIG. 25 that the pore diameter is larger in Manufacture examples 2 and 3 than in Manufacture example 1. Therefore, the pore diameter db of the porous template increases in the heat treatment step. Further, from comparison between FIG. 26 and FIG. 25, it can be seen that the pore diameter da of the porous carbon material is smaller than the pore diameter db of the porous template. A conceivable cause of this is that, in the separation step, the porous carbon material is subjected to capillary contraction when acid is used to separate the carbon layer from the porous template. In FIG. 26, it can be seen from comparison between Example 1 and Example 2 that there is little change in the pore size distribution of the porous carbon material before and after the stabilization step.

Further, the BET specific surface areas were calculated by the same method as in Example 1 for the porous templates of Manufacture example 1 and Manufacture example 2 and were 105 (m²/g) and 86 (m²/g), respectively.

### Average Framework Thickness

For the porous template of Manufacture example 2, the BET specific surface area of the porous template and the density of magnesium oxide of 3.58 [g/cm³] were substituted into formula (2) described above to calculate the average framework thickness of Manufacture example 2. The average framework thickness of the porous template of Manufacture example 2 was 19.5 nm.

$$d = 6. \times {10}^{3} / ( S \times ρ ) \qquad ( 2 )$$

(In this formula, d denotes the average framework thickness [nm], p denotes the density of materials forming the porous template [g/cm³], and S denotes the BET specific surface area of the porous template [m²/g].)

### TG Analysis

Thermogravimetry measurement was performed on the porous carbon materials of Example 1 and Example 2, the porous template of Manufacture example 1, and the molding of Manufacture example 3 by using the thermogravimetric measuring device (TGA-50 by Shimadzu Manufacturing Co., Ltd.) and a Pt-pan under atmosphere circulation. Next, the measurement results were corrected by using measurement data on an empty pan.

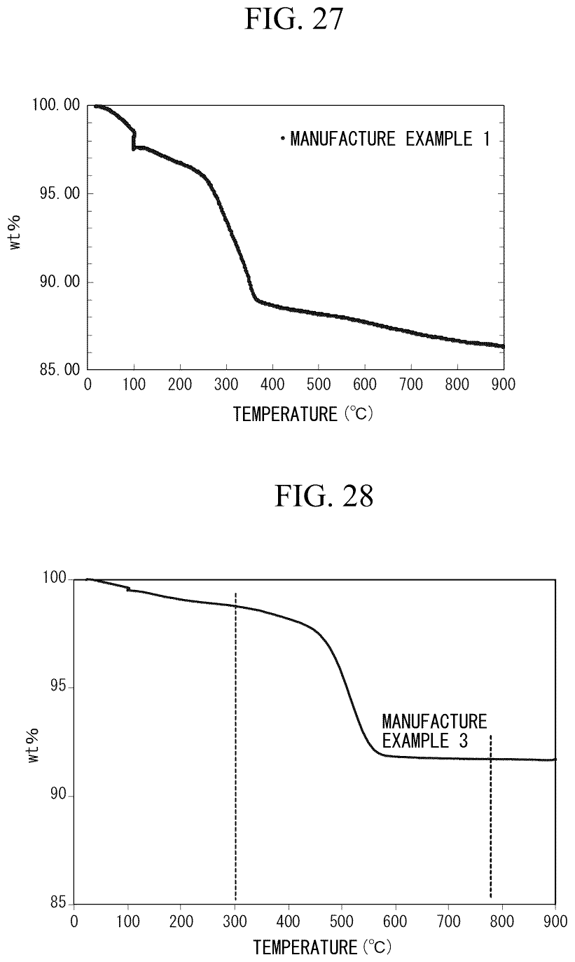

FIG. 27 represents a TG curve for the porous template of Manufacture example 1. The TG curve illustrated in FIG. 27 is data in which the rate of temperature rise in the measurement was 10° C./min in the TG analysis. The TG curve for the porous template illustrated in FIG. 27 indicates that heating of the porous template at 900° C. results in a weight reduction of about 14%. Further, it can be seen that a rapid weight reduction is exhibited around 100° C. Given that peaks of Mg(OH)₂, which are not observed in Manufacture example 2 obtained after the heat treatment, are observed in Manufacture example 1 before the heat treatment in the XRD pattern of the porous template illustrated in FIG. 20 described above, the weight reduction of the porous template is considered to be caused by decomposition of magnesium hydroxide and desorption of moisture in the air physically adsorbed in the template. Further, it is considered that this causes an increase in the pore diameter or an increase in the specific surface area as indicated in FIG. 25 to occur.

FIG. 28 represents a TG curve for the molding of Manufacture example 3. The TG curve illustrated in FIG. 28 is data in which the rate of temperature rise in the measurement was 10° C./min in the TG analysis. The vertical axis of FIG. 28 represents a ratio (%) of the weight of a sample at a predetermined temperature during TG measurement relative to the weight of the sample before heated for TG measurement.

In the TG curve illustrated in FIG. 28, the carbon loading W_{carbon} (g/g) is found. A weight reduction due to components other than carbon, such as water, is started from 100° C., and the weight is gradually reduced. However, since the slope is gentle around 300° C., the difference between the weight (%) at a high temperature (780° C.) after burning and the weight (%) at 300° C. as a reference is found to be a carbon quantity. The carbon loading was found from 7.05 of the difference between 98.76% at 300° C. and 91.71% at 780° C., and as a result, 7.58% was obtained.

Herein, the carbon loading W_{carbon} (g/g) at each temperature described above was substituted into the following formula (3) to calculate the average number of stacking layers N of the carbon layers coated on the porous template. The carbon loading W_{carbon} (g/g) means the weight of attached carbon per 1 g of the porous template. Further, in formula (3), 7.614×10⁻⁴ g/m² was used for W_{graphene}, and 86 m²/g, which is the actual measurement value of Manufacture example 2, was used for Sₜₑₘₚₗₐₜₑ. At 300° C., the average number of stacking layers of the carbon layers was 1.12, and it was confirmed that a single-layer graphene was formed in most regions.

$$[ Eq . 2 ]$$

$$N = \frac{{W}_{M}}{{W}_{graphene}} = \frac{{W}_{carbon}}{{S}_{template} {W}_{graphene}} \qquad ( 3 )$$

(In formula (3), W_{M}: a carbon quantity deposited per unit area of the porous template (g/m²), W_{graphene}: a weight per unit area of a single-layer graphene (g/m²), W_{carbon}: a carbon loading obtained from a TG curve (g/g), Sₜₑₘₚₗₐₜₑ: a specific surface area of the porous template (m²/g))

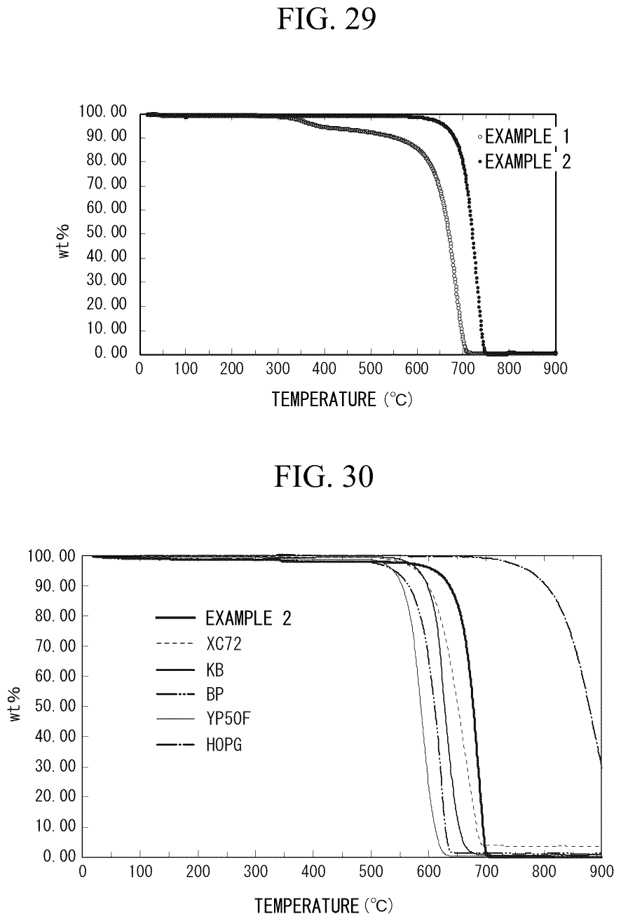

FIG. 29 represents TG curves for the porous carbon material of Example 1 and Example 2. The TG curves illustrated in FIG. 29 are data in which the rate of temperature rise in the measurement was 5° C./min in the TG analysis. As can be seen from FIG. 29, it is found that the oxidation resistance is improved in Example 2 compared to Example 1 because of the process of the stabilization step. After the TG analysis, white ash that seems to be magnesium oxide used for the template was observed in the porous carbon material of Example 1. The ash resulted after the TG analysis was 0.9 wt % of the porous carbon material before the TG analysis. The amount of the change before and after the TG analysis, which was calculated from the actual weight change measured by using a micro-balance, was 1.0 wt %. The amount of ash in Example 2 was smaller than the amount of ash in Example 1 in accordance with visual observation. Note that the sample used for measurement of the amount of ash was a separate sample from the sample used for measurement of the oxidation resistance, and these samples differ in that the rate of temperature rise in TG analysis was 10° C./min.

FIG. 30 is a diagram illustrating a TG curve of the porous carbon material of Example 2 together with TG curves of other carbon materials. The TG curves illustrated in FIG. 30 are data in which the rate of temperature rise in the measurement was 5° C./min in the TG analysis. In FIG. 30, XC72, KB, DB, BP, YP50F, and HOPG represent VULCAN XC72 (Cabot Co.), Ketjenblack EC300J (Lion Specialty Chemicals Co., Ltd.), BLACK PEARLS 2000 (Cabot Co.), YP50F, which is a steam-activated activated carbon (Kuraray Co., Ltd.), and highly oriented pyrolytic graphene, respectively. The TG analysis was also performed on these carbon materials in the same manner as in Example 1 and Example 2. It was observed that the porous carbon material of Example 2 is the second most excellent carbon material next to HOPG in terms of oxidation resistance. That is, when a mixture containing these carbon materials is heated, the finally remaining carbon material is the porous carbon material that is the same as Example 2 (GMS) or HOPG.

### Temperature-Programmed Desorption Analysis: TPD

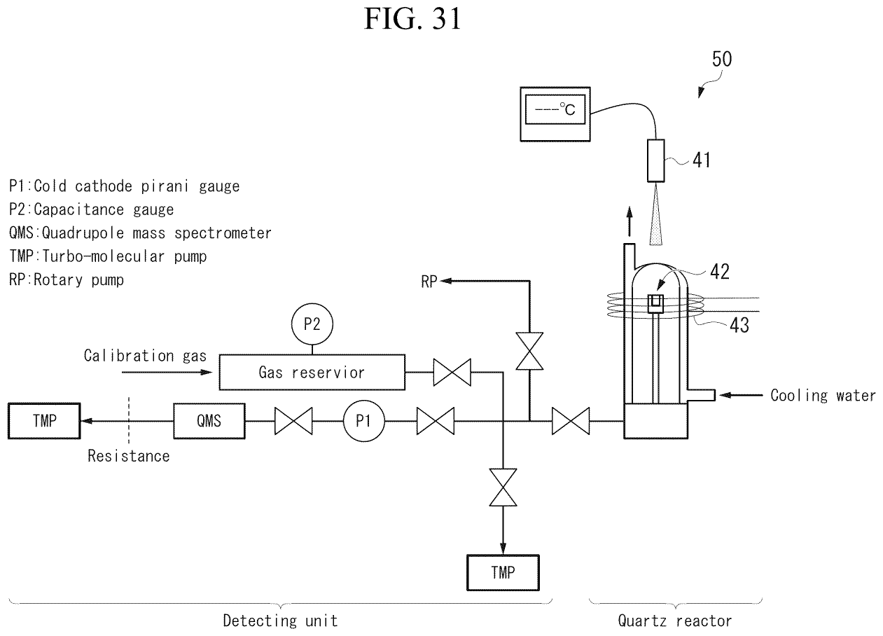

When a carbon material is heated up to 1800° C., an edge site terminated by hydrogen or oxygen is decomposed into H₂, CO, CO₂, or H₂O, and it is therefore possible to estimate the total amount of the edge site of the carbon material by measuring the emission amount of these gases. In the temperature-programmed desorption analysis, for the porous carbon materials of Example 1 and Example 2, accurate qualitative and quantitative analysis was performed on edge sites terminated by an oxygen-containing functional group or hydrogen by using an ultra-sensitive vacuum TPD device (developed by Tohoku University, see T. Ishii et al. CARBON 80, 2014, 135-145). FIG. 31 is a diagram illustrating an ultra-sensitive vacuum TPD device 50 used for Example 1 and Example 2. The ultra-sensitive vacuum TPD device 50 has a quartz reactor including a radiation thermometer 41, a sample holder 42, and a high-frequency induction coil 43 and a detecting unit connected to the quartz reactor. For example, the detecting unit includes a gas reservoir, a turbo-molecular pump TMP, a rotary pump RP, a cold cathode Pirani gauge P1, and a capacitance gauge P2. Specifically, 1 to 3 mg of each porous carbon material was put into the sample holder formed of graphite and heated under vacuum up to 1800° C. at a rate of temperature rise of 10° C./min, and a gas emitted during the heating was analyzed by mass spectrometry.

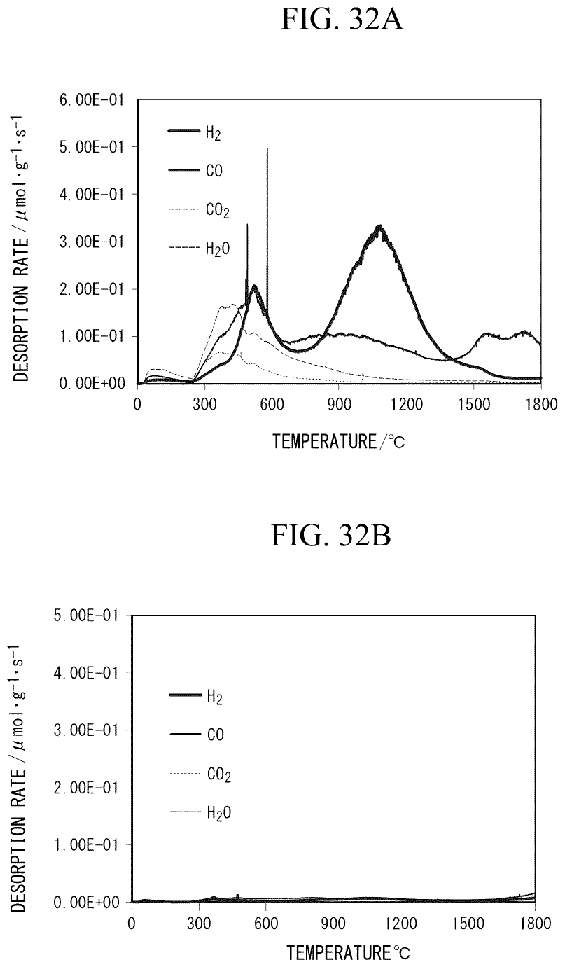

FIGS. 32A and 32B illustrate gas discharge patterns when temperature-programmed desorption analysis was performed on Example 1 and Example 2. FIG. 32A represents a result on Example 1, and FIG. 32B represents a result on Example 2. The gas discharge amount in Example 2 (0.11 mmol/g) is significantly small, which is below 5% of the gas discharge amount in Example 1 (2.4 mmol/g), and it can be seen that the amount of edge site is significantly reduced because of the process of the stabilization step. That is, even when a high voltage is applied, the electrolyte liquid is less likely to be decomposed, and the energy density can be improved.

### Total Pore Volume

For the porous carbon material of Example 2, the total pore volume was measured by converting the nitrogen adsorption amount at a relative pressure P/P₀=0.96 at −196° C. into the volume at the density of liquid nitrogen based on the adsorption/desorption isotherm. Table 3 lists the measurement result on the carbon material produced by the same scheme as in Comparative example 2 by using the secondary particle template of alumina nano-particles and the measurement result on the carbon material produced by the same scheme as in Comparative example 1 by using the secondary particle template of magnesium oxide nano-particles together with the BET specific surface areas. It was found from Table 3 that the specific surface area and the total pore volume were increased in Example 2 compared to the conventional carbon material. The value from a reference (Al₂O₃ secondary particle template) and the value from a reference (MgO secondary particle template) are based on the results in H. Nishihara et al., Adv. Funct. Mater., 2016, 26, 6418-6427, and S. Sunahiro et al., J. Mater. Chem. A., 2021, 9, 14296-14308., respectively.

TABLE 3

| | Specific | Total pore |
|---|---|---|
| | surface area | volume |
| | (m²/g) | (cm³/g) |
| Example 2 | 2060 | 3.97 |
| Value from reference | 1940 | 2.79 |
| (Al₂O₃ secondary particle template) | | |
| Value from reference | 1935 | 3.83 |
| (MgO secondary particle template) | | |

### Example 3

A porous carbon material was produced by the same method as in Example 1 except that Kyowa-mag (registered trademark) MF-30 was used as the porous template. Kyowa-mag (registered trademark) MF-30 (BET specific surface area: 24 m²/g) is formed of magnesium oxide as with Kyowa-mag (registered trademark) MF-150 (BET specific surface area: 119 m²/g). That is, in Example 3, the heat treatment step, the coating step, and the separation step were performed on the porous template of Kyowa-mag (registered trademark) MF-30 under the same conditions as in Example 1 to produce the porous carbon material.

As analysis on Example 3, first, the average framework thickness was calculated for the porous template of Example 3 obtained after the heat treatment step and was 69.8 nm.

Next, nitrogen adsorption/desorption measurement was performed in the same method as in Example 1 to calculate the specific surface area and the pore diameter. The specific surface area of the porous carbon material of Example 3 was 1200 m²/g, and the peak of the pore size distribution was at 7.3 nm. A conceivable cause of the small specific surface area of the porous carbon material of Example 3 is that the average framework thickness was large in the porous template used in Example 3, this resulted in a soft carbon framework of the carbon layer coated on the template, and therefore, the porous carbon material was significantly susceptible to the impact of capillary contraction in the separation step.

### <Diffusion Resistance>

### Example 4-1

The porous carbon material of Example 2 as an active material, Denka Black as a conductive agent, and polytetrafluoroethylene (PTFE) as a binder were mixed by using a pestle and a mortar so that the weight ratio thereof is 90:5:15 to produce a paste. Next, two sheets of compacts each having a weight of 5 mg and a size of 1 cm×1 cm made of this paste were molded. Next, these molded bodies were interposed between Pt meshes and pressurized and crimped by a handpress at a displayed pressure of around 3 KN to obtain an electrode. Two sheets of these electrodes were prepared so as to have the same weight ratio and used as a cathode and an anode, respectively. After the produced electrodes were dried in vacuum at 120° C. overnight, a coin cell was assembled in a glove box under an argon atmosphere.

In the assembly of the coin cell, a spring, a spacer, an electrolyte liquid, the anode, a separator (glass fiber), an electrolyte liquid, the cathode, a liquid electrolyte, and a spacer were laminated in this order in the lamination direction and contained between outer bodies. In the assembly of the coin cell, the electrodes and separators were lightly tightened by hand and then crimped by using a dedicated assembly apparatus (model number: HSMCC-H10, by Hosen Corporation). As the electrolyte liquid, 1M Et₄NBF₄/PC was used.

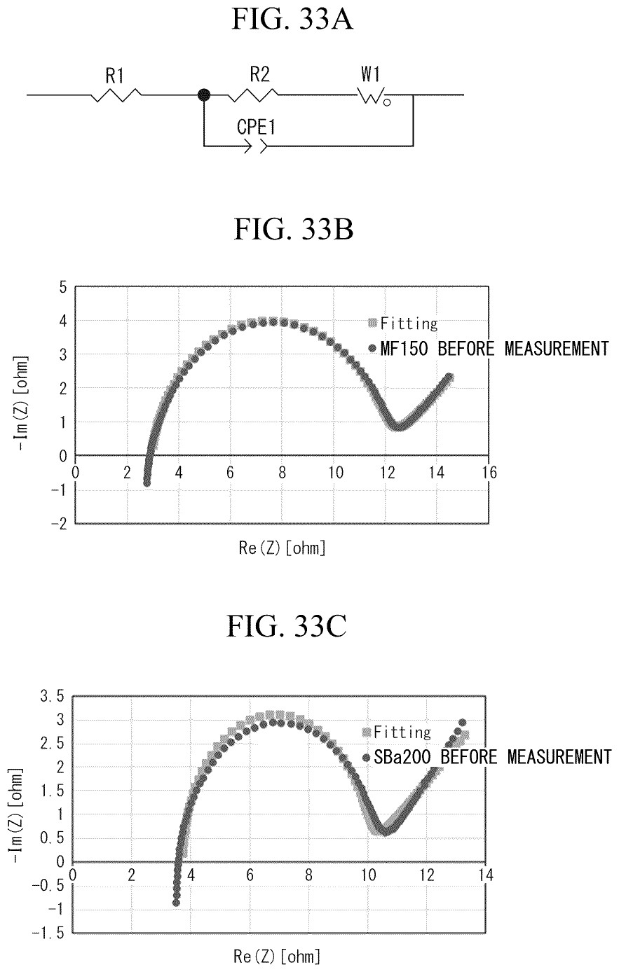

A potentiogalvanostat (Bio-Logic: VMP3) was used to perform electrochemical measurement on the produced coin cell. Specifically, after the coin cell was allowed to stand for 24 hours in an incubator maintained at 25° C., impedance measurement was performed before cyclic voltammetry or constant current charge/discharge measurement was performed. Fitting was performed on the obtained data by using analyzing software ZView2 to estimate the diffusion resistance. The equivalent circuit model illustrated in FIG. 33A was used for the analysis.

### Comparative Example 4-1

A capacitor was produced by the same method as in Example 4-1 except that the active material was changed to the carbon material of Comparative example 1, and the diffusion resistance was estimated.

FIGS. 33A to 33C represent an equivalent circuit model used for finding the diffusion resistance in Example 4-1 and Comparative example 4-1 (FIG. 33A), a Nyquist plot for Example 4-1 (FIG. 33B), and a Nyquist plot for Comparative example 4-1 (FIG. 33C). As the diffusion resistance, W1 was calculated from fitting curves of the Nyquist plots of FIG. 33B and FIG. 33C. The diffusion resistances of Example 4-1 and Comparative example 4-1 were 17.48Ω and 22.93Ω, respectively. Therefore, in the capacitor of Example 4-1, the use of the porous carbon material of Example 2 reduced the diffusion resistance.

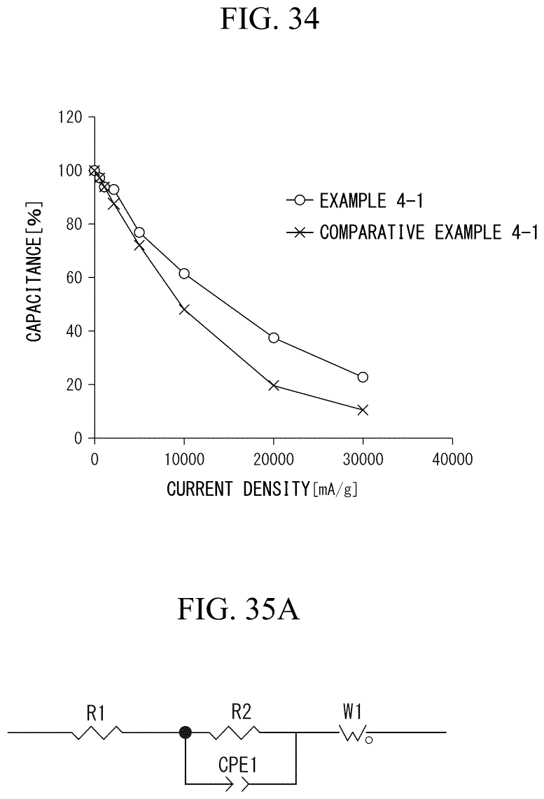

For the capacitors of Example 4-1 and Comparative example 4-1, the rate characteristic was evaluated by measuring changes in capacitance while the current value was increased. FIG. 34 is a graph illustrating rate characteristics of Example 4-1 and Comparative example 4-1.

It was confirmed from FIG. 34 that, in Example 4-1, the reduction in the capacity due to an increase in the current value was suppressed compared to Comparative example 4-1. The rate characteristic depends on a diffusion resistance and a DC resistance. In Example 4-1, it is believed that the reduction in the diffusion resistance significantly contributed to the improvement in the rate characteristic. Therefore, it was found that the rate characteristic can be improved when the porous carbon material of Example 2 is used for EDLCs.

Further, it is considered that, in Example 4-1, because the primary particle has a plate-like shape, the resistance between particles of the active material that affects the DC resistance was also reduced, which leads to the improved rate characteristic.

### Example 4-2

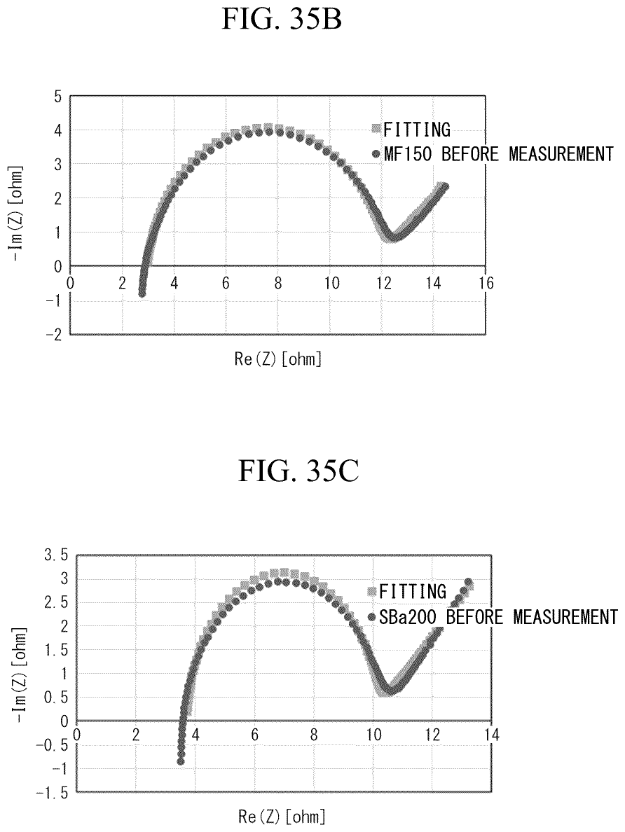

A capacitor was produced and the diffusion resistance was measured by the same method as in Example 4-1 except that the equivalent circuit model used in estimation of the diffusion resistance was changed to that illustrated in FIG. 35A.

### Comparative Example 4-2

A capacitor was produced and the diffusion resistance was measured by the same method as in Comparative example 4-1 except that the equivalent circuit model used in estimation of the diffusion resistance was changed to that illustrated in FIG. 35A.

FIGS. 35A to 35C represent the equivalent circuit model used for finding the diffusion resistance in Example 4-2 and Comparative example 4-2 (FIG. 35A), a Nyquist plot for Example 4-2 (FIG. 35B), and a Nyquist plot for Comparative example 4-2 (FIG. 35C). Fitting was performed on the Nyquist plots of FIG. 35B and FIG. 35C, and the diffusion resistances of Example 4-2 and Comparative example 4-2 were 8.454Ω and 22.96Ω, respectively. Therefore, even with the equivalent circuit model illustrated in FIG. 35A, it was confirmed that the use of the porous carbon material of Example 2 reduces the diffusion resistance.

The capacitor electrode with the porous carbon material of the present Example has a low diffusion resistance. This capacitor electrode has a number of pores in the material thereof that are resulted from the porous structure of the material in addition to the electron conductivity, and the resulting large specific surface area can provide a reaction area for a large amount of ion adsorption. In addition, fast reactivity as a capacitor electrode can be achieved because of both effects of: quick adsorption/desorption and supply of lithium ions in an electrochemical reaction due to impregnation of an electrolyte liquid into the pores; and also fast electron conduction due to the graphene structure.

Next, evaluation of the output characteristics of Examples of the energy storage device according to the present embodiment, specifically, a coin cell lithium-ion battery that is an example of energy storage devices will be described.

<Evaluation of High-Power Characteristic with Test Batteries>

### Example 5

### <Production of Test Batteries>

A cathode material paste was produced by mixing and stirring 95% by weight of NCM cathode material (Li_{1.01}Ni_{0.33}Co_{0.33}Mn_{0.33}O₂) powder with the average particle diameter of 10 μm, 2% by weight of the porous carbon material of Example 1 as the conductive agent, and 3% by weight of PVdF so as to be uniform with the use of N-methyl-pyrrolidone (NMP) as a solvent. This paste was applied onto an AI current collector having a thickness of 15 m, then dried at 110° C., then punched into Φ15 mm, and pressurized at 30 kN to obtain an anode. After this electrode is dried in vacuum at 120° C., 1M LiPF₆ solution (mixture solvent of ethylene carbonate (EC):diethyl carbonate (DEC)=1:1) for the electrolyte liquid and a polypropylene separator were used within a glove box under argon gas atmosphere, and thereby a 2032-size coin cell test battery having a pair of metal Li counter electrodes was produced.

### <Evaluation of Test Battery>

Constant current of 1 mA (corresponding to 0.2C) was conducted in each test battery until the charged voltage reached 4.2 V and then continued to be charged with a constant voltage until the current became 0.05 mA (0.05C) after 4.2 V was reached. The test battery was then discharged at constant current of 1 mA to 3 V. The discharge capacity and the average voltage during this process were found. Next, constant current of 1 mA (corresponding to 0.2C) was conducted in the same test battery until the charged voltage reached 4.2 V and then continued to be charged with a constant voltage until the current became 0.05 mA (0.05C) after 4.2 V was reached. The test battery was then discharged at constant current of 30 mA (corresponding to 5C) to 3 V. FIG. 37 illustrates discharge curves with different current values during discharge.

The discharge capacity and the average voltage in the evaluation test described above were found. The 5C retention rate (5C capacity/0.2C capacity) and the average voltage drop (0.2C average voltage-5C average voltage) were then found.

### Comparative Example 5-1

A test battery was produced under the same conditions as in Example 5 except that the carbon material of Comparative example 1 was used for the conductive agent instead of the porous carbon material of Example 1. The test battery was then evaluated by the same method as in Example 5.

### Comparative Example 5-2

A test battery was produced under the same conditions as in Example 5 except that the carbon material of Comparative example 2 was used for the conductive agent instead of the porous carbon material of Example 1. The test battery was then evaluated by the same method as in Example 5.

### Comparative Example 5-3

A test battery was produced under the same conditions as in Example 5-1 except that the carbon material of Comparative example 3 was used for the conductive agent instead of the porous carbon material of Example 1. The test battery was then evaluated by the same method as in Example 5.

### Comparative Example 5-4

A test battery was produced under the same conditions as in Example 5-1 except that acetylene black (product name: DENKA BLACK, by Denka Company Limited) was used for the conductive agent instead of the porous carbon material of Example 1. The test battery was then evaluated by the same method as in Example 5.

The results are listed in Table 4.

TABLE 4

| | 0.2 C discharge | | 5 C discharge | | 5 C discharge | 0.2 C-5 C |
|---|---|---|---|---|---|---|
| | Capacity | Average | Capacity | Average | Capacity retention | Average voltage |
| | (mAh/g) | voltage (V) | (mAh/g) | voltage (V) | rate (%) | drop (V) |
| Example 5 | 153 | 3.85 | 332 | 3.61 | 86.3% | 0.24 |
| Comparative | 152 | 3.84 | 118 | 3.57 | 77.6% | 0.27 |
| example 5-1 | | | | | | |
| Comparative | 151 | 3.83 | 103 | 3.53 | 68.2% | 0.3 |
| example 5-2 | | | | | | |
| Comparative | 151 | 3.84 | 112 | 3.55 | 74.2% | 0.29 |
| example 5-3 | | | | | | |
| Comparative | 150 | 3.83 | 88 | 3.51 | 58.7% | 0.32 |
| example 5-4 | | | | | | |

It has been proved that the porous carbon material of the present embodiment sufficiently functions as a conductive agent for the cathode, exhibits a high retention rate of capacity and a high discharge voltage even with large current, and improves the high-power characteristic. According to the porous carbon material of the present embodiment, the porous carbon material has a number of pores in the material thereof that are resulted from the porous structure of the material in addition to the electron conductivity, and fast reactivity of active substance materials can be achieved because of both effects of quick supply of lithium ions in a battery reaction due to impregnation of an electrolyte liquid into the pores and also fast electron conduction due to the graphene structure.

The above advantageous effects can be suitably applied to anode materials without being limited to cathode materials, and both effects on the electron conduction and the ionic conduction can be achieved even with Li alloy-based anode materials with Si or the like in addition to typical graphite anodes. Therefore, the output characteristic of a rechargeable battery can be improved in the use for a cathode alone and the use for an anode alone or in the use for both cathodes and anodes.

### REFERENCE SIGNS LIST

10A, 10B primary particle
11 first wall
12 second wall
20 porous template
30 molding
35 carbon layer
100A porous carbon material (GMS)
100B porous carbon material (CMS)
P pore
da pore diameter (of porous carbon material)
d average framework thickness (of porous template)
db pore diameter (of porous template)
G gap
200 energy storage device (lithium-ion battery)
211 exterior component
212 cathode
213 exterior component
214 anode
215 separator
217 sealing gasket
218 spring
219 spacer

1. A porous carbon material comprising a graphene framework,
wherein a plurality of pores are provided inside a primary particle forming the porous carbon material, and
wherein the particle diameter of the primary particle is 300 nm or greater and 30 μm or less.

2. The porous carbon material according to claim 1, wherein the primary particle has a plate-like shape, the ratio of an in-plane direction length relative to a thickness of the plate-like shape being three or greater.

3. The porous carbon material according to claim 1, wherein the primary particle has a plate-like shape, the porous carbon material comprising:
a first wall mainly forming a plate-like primary surface; and
a second wall formed inside the primary particle and forming a part of a partition inside a particle.

4. The porous carbon material according to claim 1, wherein a diffusion resistance of a capacitor obtained with the porous carbon material is 20Ω or less.

5. The porous carbon material according to claim 1, wherein a pore diameter of the porous carbon material is 2 nm or greater and 50 nm or less.

6. A manufacturing method of a porous carbon material, the manufacturing method comprising:
a coating step of coating a porous template with a carbon layer to obtain a molding, a primary particle diameter of the porous template being 300 nm or greater and 30 μm or less; and
a separation step of dissolving the porous template with acid to separate the molding from the porous template.

7. The manufacturing method of the porous carbon material according to claim 6 further comprising, prior to the coating step, a heat treatment step of performing heat treatment on the porous template.

8. The manufacturing method of the porous carbon material according to claim 6, wherein the porous template is formed of particles made of oxide of alkali earth metal.

9. The manufacturing method of the porous carbon material according to claim 8, wherein the oxide of alkali earth metal is magnesium oxide.

10. The manufacturing method of the porous carbon material according to claim 8, wherein in the separation step, the porous template is dissolved with acid not containing hydrofluoric acid.

11. The manufacturing method of the porous carbon material according to claim 6 further comprising, after the separation step, a stabilization step of performing heat treatment on a molding separated from the porous template by the separation step.

12. The manufacturing method of the porous carbon material according to claim 6, wherein an average framework thickness of the porous template is 70 nm or less.

13. An electrode for a capacitor, the electrode comprising an electrode with the porous carbon material according to claim 1.

14. An anode for an energy storage device, the anode including the porous carbon material according to claim 1 as a conductive agent.

15. A cathode for an energy storage device, the cathode including the porous carbon material according to claim 1 as a conductive agent.

16. An energy storage device comprising a cathode and/or an anode including the porous carbon material according to claim 1 as a conductive agent.
